(19) United States
(12) Patent Application Publication
(10) Pub. No.: US 2026/0228178 A1
(43) Pub. Date: Aug. 6, 2026

(54) HARDWARE OPERATIONAL STATE MONITORING AND MANAGEMENT IN A RECONFIGURABLE DATAFLOW ARCHITECTURE

(71) Applicant: SambaNova Systems, Inc., Palo Alto, CA (US)

(72) Inventors: Raghunath SHENBAGAM, San Ramon, CA (US); Pushkar Shridhar NANDKAR, Hayward, CA (US); Juan DOMINGUEZ, Palo Alto, CA (US); Benjamin GLICK, Palo Alto, CA (US); Arjun Rajiv SABNIS, San Francisco, CA (US); Shivam RAIKUNDALIA, Palo Alto, CA (US); Kyle MAY, Palo Alto, CA (US)

(73) Assignee: SambaNova Systems, Inc., Palo Alto, CA (US)

(21) Appl. No.: 19/043,389

(22) Filed: Jan. 31, 2025

(51) Int. Cl. G06F 15/78; G06F 11/07

(52) U.S. Cl. CPC G06F 15/7875; G06F 11/0721; G06F 11/0796; G06F 15/7892

(57) ABSTRACT

A system includes an RDU coupled to a local interconnect and configured to receive a workload for execution from a host via a system interconnect coupled to the local interconnect, and an RDRT architecture executing on the host and configured to record, in a memory of the host, an RDU state of the RDU, and, when the RDU state is FAULTED, prevent further processing associated with the execution of the workload using the RDU.

### BACKGROUND

### Field of the Disclosure

The present disclosure relates generally to a reconfigurable dataflow architecture for accelerating workloads and, more particularly, to methods and systems for hardware operational state monitoring and management in a reconfigurable dataflow architecture.

### Description of the Related Art

Data processing and computer science have seen a revolution in learning capability and performance with the advent of artificial intelligence (AI) and machine learning (ML) based on neural networks (NN) as a core topology using parallel processing algorithms. Many AI/ML applications have been performed by conventional computer architectures based on sequential control flow, in which an instruction set is sequentially executed by a central processing unit (CPU). However, very large AI/ML applications, such as involved with large language models (LLMs), may not be particularly well matched with the capabilities of CPU based computer system.

Therefore, in addition to the CPU, computer systems including a graphics processing unit (GPU) have been used to accelerate the parallel processing involved with AI/ML applications. GPUs that were designed to accelerate graphics output to a display were found to also accelerate the AI/ML applications in a similar manner. The use of CPU/GPU computer systems may provide a limited potential for acceleration of various workloads, and in particular very large AI/ML applications, due to constraints with memory access as well as due to overall power consumption, which can be undesirable.

### SUMMARY

In one aspect, a first system for hardware operational state monitoring and management in a reconfigurable dataflow architecture is disclosed. The first system may include an RDU coupled to a local interconnect and configured to receive a workload for execution from a host via a system interconnect coupled to the local interconnect, and an RDRT architecture executing on the host and configured to process the execution of the workload using the RDU. In the first system, the RDRT architecture may be configured to record, in a memory of the host, an RDU state of the RDU, and, when the RDU state is FAULTED, prevent further processing associated with the execution of the workload using the RDU.

In any of the disclosed embodiments of the first system, the RDRT architecture may further be configured to determine that the RDU state OP_PENDING for a recovery action generated a fault, transition the RDU state to FAULTED, transition the RDU state to INIT for an initialization, and, when the initialization fails, transition the state to DIAG for a diagnostic. After the diagnostic or when the initialization succeeds, the RDRT architecture may further be configured to transition the state to READY.

In any of the disclosed embodiments of the first system, the RDRT architecture may further be configured to detect presence of the RDU when the RDU state is ABSENT, and, responsive to detecting presence of the RDU, transition the RDU state to INIT.

In any of the disclosed embodiments of the first system, responsive to detecting the RDU state is INIT, the RDRT architecture may further be configured to trigger an initialization of at least a portion of the RDU, transition the RDU state to READY when the initialization succeeds; and, responsive to detecting absence of the RDU, transition the RDU state to ABSENT.

In any of the disclosed embodiments of the first system, responsive to receiving a first error generated in INIT or DIAG, the RDRT architecture configured to transition the RDU state to READY may be further configured to transition the RDU state to DEGRADED, while the first error may indicate constrained operation of the RDU, begin quiescing a first portion of the RDU associated with the first error and transition the RDU state to QSC_PENDING, confirm the quiescing of the first portion and transition the RDU state to QSC_DONE, transition the RDU state to OP_PENDING while the recovery action is performed, and transition the RDU state to READY when the recovery action is successfully completed.

In any of the disclosed embodiments of the first system, responsive to detecting that the RDU state is READY, the RDRT architecture may further be configured to receive a first workload for execution the RDU, and process the workload for execution on the RDU.

In any of the disclosed embodiments of the first system, when the RDU state is READY, the RDRT architecture may further be configured to receive an indication that the workload was successfully completed.

In any of the disclosed embodiments of the first system, when the RDU state is OP_PENDING, the RDRT architecture may further be configured to receive a second error that the workload was not successfully completed, while the second error may be associated with a second portion of the RDU or is associated with a timeout, and, responsive to the second error, transition the RDU state to FAULTED.

In another aspect, a first method for hardware operational state monitoring and management in a reconfigurable dataflow architecture is disclosed. The first method may include recording, in a memory of a host, an RDU state of an RDU coupled to a local interconnect and configured to receive a workload for execution from the host via a system interconnect coupled to the local interconnect, the first method may also include detecting, by an RDRT architecture executing on the host and configured to process the execution of the workload using the RDU, that the RDU state is FAULTED, and preventing further processing associated with the execution of the workload using the RDU.

In any of the disclosed embodiments, the first method may further include determining that the RDU state OP_PENDING for a recovery action generated a fault, transitioning the RDU state to FAULTED, transition the RDU state to INIT for an initialization, when the initialization fails, transitioning the state to DIAG for a diagnostic, and, after the diagnostic or when the initialization succeeds, transitioning the state to READY.

In any of the disclosed embodiments, the first method may further include detecting presence of the RDU when the RDU state is ABSENT, and, responsive to detecting presence of the RDU, transitioning the RDU state to INIT.

In any of the disclosed embodiments, responsive to detecting the RDU state is INIT, the first method may further include triggering an initialization of at least a portion of the RDU, transitioning the RDU state to READY when the initialization succeeds, and, responsive to detecting absence of the RDU, transitioning the RDU state to ABSENT.

In any of the disclosed embodiments of the first method, responsive to receiving a first error generated during the initialization of the RDU, transitioning the RDU state to READY may further include transitioning the RDU state to DEGRADED, while the first error may indicate constrained operation of the RDU. The first method may further include beginning quiescing a first portion of the RDU associated with the first error and transition the RDU state to QSC_PENDING, confirming the quiescing of the first portion and transition the RDU state to QSC_DONE, transitioning the RDU state to OP_PENDING while the recovery action is performed, and transitioning the RDU state to READY when the recovery action is successfully completed.

In any of the disclosed embodiments, responsive to detecting that the RDU state is READY, the first method may further include receiving a first workload for execution the RDU, and processing the workload for execution on the RDU.

In any of the disclosed embodiments, when the RDU state is READY, the first method may further include receiving an indication that the workload was successfully completed.

In any of the disclosed embodiments, when the RDU state is OP_PENDING, the first method may further include receiving a second error that the workload was not successfully completed, while the second error may be associated with a second portion of the RDU or is associated with a timeout. Responsive to the second error, the second method may include transitioning the RDU state to FAULTED.

In yet another aspect, a tangible first computer-readable media comprising instructions executable by a computer system for hardware operational state monitoring and management in a reconfigurable dataflow architecture is disclosed. In the first computer-readable media, the instructions may include instructions to record, in a memory of a host, an RDU state of an RDU coupled to a local interconnect and configured to receive a workload for execution from the host via a system interconnect coupled to the local interconnect. In the first computer-readable media, the instructions may include instructions to detect, by an RDRT architecture executing on the host and configured to process the execution of the workload using the RDU, that the RDU state is FAULTED, and prevent further processing associated with the execution of the workload using the RDU.

In any of the disclosed embodiments of the first computer-readable media, the instructions may include instructions to determine that the RDU state OP_PENDING for a recovery action generated a fault, transition the RDU state to FAULTED, transition the RDU state to INIT for an initialization. In first computer-readable media, when the initialization fails, the instructions may include instructions to transition the state to DIAG for a diagnostic, and, after the diagnostic or when the initialization succeeds, transition the state to READY. In any of the disclosed embodiments of the first computer-readable media, the instructions may include instructions to detect presence of the RDU when the RDU state is ABSENT, and, responsive to detecting presence of the RDU, transition the RDU state to INIT.

In any of the disclosed embodiments of the first computer-readable media, responsive to detecting the RDU state is INIT, the instructions may include instructions to trigger an initialization of at least a portion of the RDU, transition the RDU state to READY when the initialization succeeds, and responsive to detecting absence of the RDU, transition the RDU state to ABSENT.

In any of the disclosed embodiments of the first computer-readable media, responsive to receiving a first error generated during the initialization of the RDU, the instructions to transition the RDU state to READY may further include instructions to transition the RDU state to DEGRADED, while the first error may indicate constrained operation of the RDU. In the first computer-readable media, the instructions may include instructions to begin quiescing a first portion of the RDU associated with the first error and transition the RDU state to QSC_PENDING, confirm the quiescing of the first portion and transition the RDU state to QSC_DONE, transition the RDU state to OP_PENDING while the recovery action is performed, and transition the RDU state to READY when the recovery action is successfully completed.

In any of the disclosed embodiments of the first computer-readable media, responsive to detecting that the RDU state is READY, the instructions may include instructions to receive a first workload for execution the RDU, and process the workload for execution on the RDU.

In any of the disclosed embodiments of the first computer-readable media, when the RDU state is READY, the instructions may include instructions to receive an indication that the workload was successfully completed.

In any of the disclosed embodiments of the first computer-readable media, when the RDU state is OP_PENDING, the instructions may include instructions to receive a second error that the workload was not successfully completed, while the second error may be associated with a second portion of the RDU or may be associated with a timeout, and, responsive to the second error, transition the RDU state to FAULTED.

In still a further aspect, a second system for hardware fault detection and recovery in a reconfigurable dataflow architecture is disclosed. The second system may include an RDU coupled to a local interconnect and configured to receive a workload for execution from a host via a system interconnect coupled to the local interconnect, and an RDRT architecture executing on the host and configured to process the execution of the workload using the RDU. In the second system, the RDRT architecture may further be configured to detect a hung state of an RDU resource on the RDU, while the RDU resource may be selected from at least one of: an RDU tile, an RDU die, or the RDU, and initiate a recovery mechanism associated with the RDU resource, where the RDU resource may be returned to an operational state from the hung state.

In any of the disclosed embodiments of the second system, the hung state of the RDU resource may be associated with a bitfile including compiled instructions executable by the RDU for configuring the RDU to execute the workload.

In any of the disclosed embodiments of the second system, prior to initiating the recovery mechanism, the RDRT architecture may further be configured to retry at least a portion of the workload on the RDU.

In any of the disclosed embodiments of the second system, the RDU may be one of multiple RDUs being used to execute the workload, while the RDRT architecture configured to retry at least a portion of the workload may further include the RDRT architecture configured to rollback execution of the workload to a last successful checkpoint specified in the bitfile.

In any of the disclosed embodiments of the second system, the RDRT architecture configured to detect the hung state of the RDU resource on the RDU may further include the RDRT architecture configured to detect a timeout associated with a control-status register (CSR) on the RDU that is indicative of the RDU resource, and prevent additional portions of the workload from being processed by the RDU.

In any of the disclosed embodiments, the second system may further be configured to designate the workload as failing to execute on the RDU, transition an RDU state for the RDU to FAULTED, and initiate quiescing of the RDU resource.

In any of the disclosed embodiments of the second system, the RDRT architecture may further be configured to cycle through a selection of a first RDU resource in order of: the RDU tile, the RDU die, the RDU, and an RDU system including the RDU, and reset the first RDU resource using a control mechanism for the RDU resource included in the RDU system. when the control mechanism for resetting the RDU resource results in the RDU returning to the operational state, the RDRT architecture may further be configured to stop cycling through the selection, else continue cycling through the selection. In the second system, when the cycling through the selection of the first RDU resource does not result in the RDU returning to the operational state, the RDRT architecture may further be configured to initiate a power reset of the RDU system.

In a yet a further aspect, a second method for hardware fault detection and recovery in a reconfigurable dataflow architecture is disclosed. The second method may include detecting a hung state of an RDU resource on an RDU, while the RDU resource may be selected from at least one of: an RDU tile, an RDU die, or the RDU. The second method may also include initiating a recovery mechanism associated with the RDU resource, while the RDU resource may be returned to an operational state from the hung state.

In any of the disclosed embodiments of the second method, the hung state of the RDU resource may be associated with a bitfile including compiled instructions executable by the RDU for configuring the RDU to execute the workload.

In any of the disclosed embodiments, prior to initiating the recovery mechanism, the second method may further include retrying at least a portion of the workload on the RDU.

In any of the disclosed embodiments of the second method, the RDU may be one of multiple RDUs being used to execute the workload, while retrying at least a portion of the workload may further include rolling back execution of the workload to a last successful checkpoint specified in the bitfile.

In any of the disclosed embodiments of the second method, detecting the hung state of the RDU resource on the RDU may further include detecting a timeout associated with a control-status register (CSR) on the RDU that is indicative of the RDU resource, and preventing additional portions of the workload from being processed by the RDU.

In any of the disclosed embodiments, the second method may further include designating the workload as failing to execute on the RDU, transitioning an RDU state for the RDU to FAULTED, and initiating quiescing of the RDU resource.

In any of the disclosed embodiments, the second method may further include cycling through a selection of a first RDU resource in order of: the RDU tile, the RDU die, the RDU, and an RDU system including the RDU, and resetting the first RDU resource using a control mechanism for the RDU resource included in the RDU system. In any of the disclosed embodiments, when the control mechanism for resetting the RDU resource results in the RDU returning to the operational state, the second method may further include stopping cycling through the selection, else continuing cycling through the selection. In any of the disclosed embodiments, when the cycling through the selection of the first RDU resource does not result in the RDU returning to the operational state, the second method may further include initiating a power reset of the RDU system.

In another aspect, tangible second computer-readable media comprising instructions executable by a computer system for hardware fault detection and recovery in a reconfigurable dataflow architecture are disclosed. In the second computer-readable media, the instructions may include instructions to detect a hung state of an RDU resource on a reconfigurable dataflow unit (RDU), while the RDU resource may be selected from at least one of: an RDU tile, an RDU die, or the RDU, and initiating a recovery mechanism associated with the RDU resource, wherein the RDU resource is returned to an operational state from the hung state. In the second computer-readable media, the hung state of the RDU resource may be associated with a bitfile including compiled instructions executable by the RDU for configuring the RDU to execute the workload.

In any of the disclosed embodiments of the second computer-readable media, the instructions may include instructions to, prior to initiating the recovery mechanism, retry at least a portion of the workload on the RDU.

In any of the disclosed embodiments of the second computer-readable media, the RDU may be one of multiple RDUs being used to execute the workload, while the instructions to retry at least a portion of the workload may further include instructions to roll back execution of the workload to a last successful checkpoint specified in the bitfile. In any of the disclosed embodiments of the second computer-readable media, the instructions to detect the hung state of the RDU resource on the RDU may further include instructions to detect a timeout associated with a control-status register (CSR) on the RDU that is indicative of the RDU resource, and prevent additional portions of the workload from being processed by the RDU.

In any of the disclosed embodiments of the second computer-readable media, the instructions may include instructions to designate the workload as failing to execute on the RDU, transition an RDU state for the RDU to FAULTED, and initiate quiescing of the RDU resource. In any of the disclosed embodiments of the second computer-readable media, the instructions may include instructions to cycle through a selection of a first RDU resource in order of: the RDU tile, the RDU die, the RDU, and an RDU system including the RDU, and reset the first RDU resource using a control mechanism for the RDU resource included in the RDU system. In the second computer-readable media, when the control mechanism for resetting the RDU resource results in the RDU returning to the operational state, the instructions may include instructions to stop cycling through the selection, else continuing cycling through the selection. In the second computer-readable media, when the cycling through the selection of the first RDU resource does not result in the RDU returning to the operational state, the instructions may include instructions to initiate a power reset of the RDU system.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a block diagram of a reconfigurable dataflow architecture, in one embodiment;

FIG. 2 is a block diagram of a high-performance computer (HPC) host, in one embodiment;

FIG. 3 is a block diagram of a computer system host, in one embodiment;

FIG. 4 is a depiction of a neural network (NN) model, in one embodiment;

FIG. 5 is a block diagram of a reconfigurable dataflow unit (RDU) system compilation, in one embodiment;

FIG. 6 is a block diagram of a reconfigurable dataflow runtime (RDRT) architecture, in one embodiment;

FIG. 7 is a block diagram of an RDU, in one embodiment;

FIG. 8 is a block diagram of an RDU die, in one embodiment;

FIG. 9 is a block diagram of an RDU tile, in one embodiment;

FIG. 10 is a block diagram of an RDU operational state monitoring and management subsystem, in one embodiment;

FIG. 11 is a state diagram of RDRT supervisor operational states, in one embodiment;

FIG. 12 is a state diagram of RDRT driver operational states, in one embodiment;

FIG. 13 is a state diagram of RDU operational states, in one embodiment;

FIG. 14 is a flow chart of a method for hardware operational state monitoring and management, in one embodiment; and

FIG. 15 is a flow chart of a method for hardware fault detection and recovery, in one embodiment.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, as an example (not shown in the drawings), device “12-1” refers to an instance of a device class, which may be referred to collectively as devices “12” and any one of which may be referred to generically as a device “12”. In the figures and the description, like numerals are intended to represent like elements.

As noted previously, typical CPU/GPU computer architectures may be constrained in performance and power consumption, especially for processing very large AI/ML applications. To overcome certain limitations of typical CPU/GPU computer architectures, a reconfigurable dataflow architecture, as further described in detail herein, has been developed. In particular, the reconfigurable dataflow architecture can provide parallel processing using multiple compute units that are simpler than typical CPUs, and therefore, can operate faster and consume less power for comparable workloads. The reconfigurable dataflow architecture may be particularly suited for workloads associated with respective layers or stages in a NN defining a computational model for execution, and may be dimensioned or scaled for very large workloads corresponding to very large NNs.

The workload executed by the reconfigurable dataflow architecture may include training procedures for developing and tuning a particular model, such as an LLM. The workload executed by the reconfigurable dataflow architecture may also include usage of a trained model to generate desired output from input, also referred to as ‘inference’ using the trained model.

As noted, the reconfigurable dataflow architecture includes relatively simple modular components that are designed for parallelized workloads, such as AI/ML applications. In the reconfigurable dataflow architecture, the coordination and control of workload processing is performed by a ‘host’ that is an external computer system that may operate using a conventional CPU and a corresponding operating system that supports sequential processing of instructions fed to the CPU, among other data processing capabilities. Accordingly, various management and configuration tasks for the reconfigurable dataflow architecture may be performed within the operating system executing at the host.

The management and configuration tasks performed by the reconfigurable dataflow architecture include hardware operational state monitoring and management, along with hardware fault detection and recovery. Operational state monitoring involves monitoring and management tasks associated with the execution of workloads on the RDU, as will be explained in further detail. In particular, during runtime, various portions of the workload may be processed by different hardware elements in the RDU as the hardware target platform, which is controlled by the RDRT architecture comprising various software layers on the host coupled to the RDU system that includes the RDU. The execution flow involves compilation of a bitfile that contains RDU-specific instructions for configuring the RDU to execute the workload.

When the workload is, for example, an AI/ML application the RDU can be configured to execute a graph that is specified in the bitfile. Because the execution paradigm of the RDU system is a dataflow paradigm that involves a parallelized flow of data through the RDU various hardware elements in the RDU can thus operate together and coordinate their actions to execute the graph, such as to perform certain parallelized computations associated with NN processing, in particular embodiments. As a result, there is a coordination aspect between certain software modules in the RDRT architecture and the hardware elements in the RDU, particularly during runtime of the workload. In various embodiments, an RDRT driver may perform scheduling of workload tasks for various hardware elements in the RDU and may thus be involved with, or responsible for, determining the operational state of the RDU or certain hardware elements in the RDU.

For example, the RDRT architecture may have indications to access certain hardware elements, as described in further detail below, and accordingly should be aware whether hardware elements are operating normally and can be accessed or not. In particular, an RDRT supervisor and an RDRT driver, as disclosed herein, may be involved with accessing the hardware elements in the RDU at certain times for certain purposes. However, the hardware elements in the RDU may be in different operational states at different times and may, therefore, be unable to respond synchronously to software requests by the RDRT architecture at certain times or in certain hardware operational states. Without some kind of operational state monitoring, the RDRT architecture may not be able to perform command and control access due to a lack of coordination with the operational states of the hardware elements in the RDU. Furthermore, as noted, different software modules in the RDRT architecture may attempt to access the hardware elements in the RDU asynchronously with each other, but which may conflict with each other or with the hardware operational state at the time of access. For these reasons, methods and systems for hardware operational state monitoring and management have been developed and are disclosed herein to enable coordination of software modules in the RDRT architecture with each other and with the hardware elements in the RDU.

Within the RDU, various circuit elements and hardware structures exist to coordinate and synchronize the workflow. As will be described in further detail, RDU tiles included within the RDU contain pattern compute units (PCU) and pattern memory units (PMU) pairs that perform the parallelized computations associated with processing the workload. Additionally, multiple address generation and coalescing units (AGCUs) included with the RDU tile are configured to coordinate and monitor the dataflow to and from the PCU/PMU pairs. Each of these elements may be associated with certain control and status registers (CSRs) as well as other management and control features that can handle certain types of errors internally, such as a divide by zero error. However, because the RDU tile, along with certain internal elements in the RDU tile, are subject to configuration by the bitfile associated with the workload, certain errors may occur from which the RDU may not be able to recover without external action, which is referred to as a “hung” state. For example, for a certain calculation, such as a softmax function calculation, the AGCU may coordinate producers and consumers of intermediate values associated with a given softmax function instance being executed in the RDU tile that is specified by the bitfile. Because the RDU tile must follow the configuration data specified in the bitfile, error originating in the bitfile may result in a hung state of hardware elements (also referred to as RDU resources) in the RDU.

Depending on a specific RDU resource (e.g., hardware element in the RDU) associated with the hung state, different procedures and corresponding structures, like CSRs, may be available for recovery. For these reasons, methods and systems for hardware fault detection and recovery have been developed and are disclosed herein to enable fault detection, analysis, and coordinated recovery along with the hardware monitoring and management discussed above in the RDRT architecture.

As disclosed herein, hardware monitoring and management in the reconfigurable dataflow architecture can provide an RDU state buffer in host memory that is accessible to software processes executing in a host user space or a host kernel space. The RDU state buffer can include defined states and defined transitions between states for hardware monitoring and management and for hardware fault detection and recovery, as disclosed herein. The hardware monitoring and management in the reconfigurable dataflow architecture disclosed herein can provide for ‘legal’ access to RDU resources at certain times, while preventing ‘illegal’ access at times when RDU resources are unavailable or cannot be accessed for various reasons. For example, the illegal access can be associated with different hardware operational states reflected by the RDU state buffer. Such illegal access can result in further disruption or compounded errors in the RDU that are undesirable. The hardware monitoring and management in the reconfigurable dataflow architecture can provide for protocols and responsibility for updating the RDU state buffer by software modules in the reconfigurable dataflow architecture, such as from host user space or from host kernel space.

In particular embodiments, the hardware monitoring and management in the reconfigurable dataflow architecture disclosed herein can provide for fault recovery for certain operational conditions using software commands to access RDU resources that remain responsive and can enable recovery to a ready state. The hardware fault detection and recovery in the reconfigurable dataflow architecture disclosed herein can provide for detection and recovery when a particular RDU resource is in a hung state and is no longer directly responsive to such software commands, and can enable recovery to a ready state. The hardware fault detection and recovery in the reconfigurable dataflow architecture disclosed herein can provide for performing certain predefined cycles of resetting to recover from the hung state of a given RDU resource to a ready state.

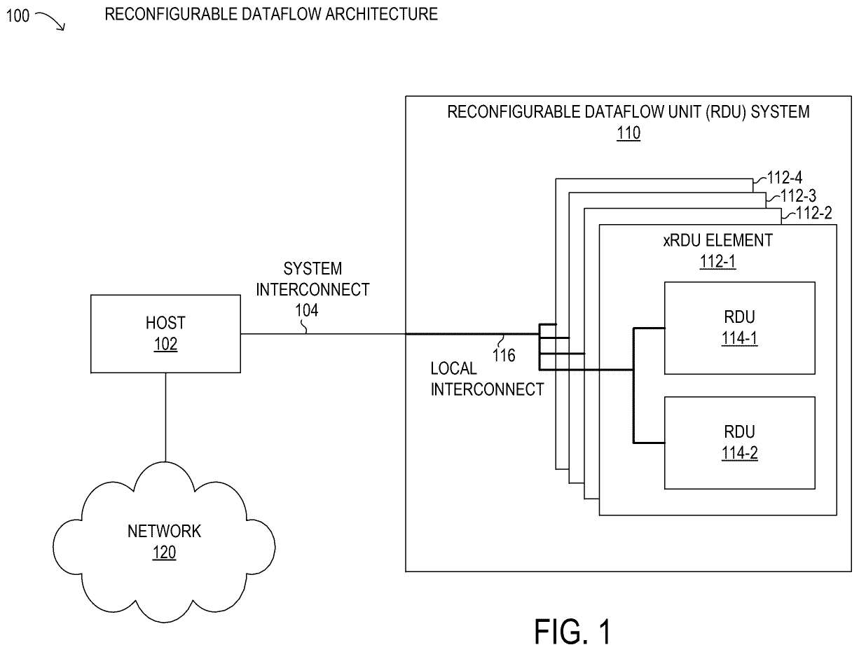

Referring now to the drawings, FIG. 1 depicts a block diagram of a reconfigurable dataflow architecture 100, or simply referred to as architecture 100, in one embodiment. FIG. 1 is a schematic illustration and is not necessarily drawn to scale or perspective. FIG. 1 is an exemplary implementation of reconfigurable dataflow architecture 100 for descriptive purposes. In some embodiments, reconfigurable dataflow architecture 100 may include or represent various different components and interconnections. As shown in FIG. 1, reconfigurable dataflow architecture 100 includes a host 102 coupled to an RDU system 110 by a system interconnect 104, while host 102 is also coupled to a network 120.

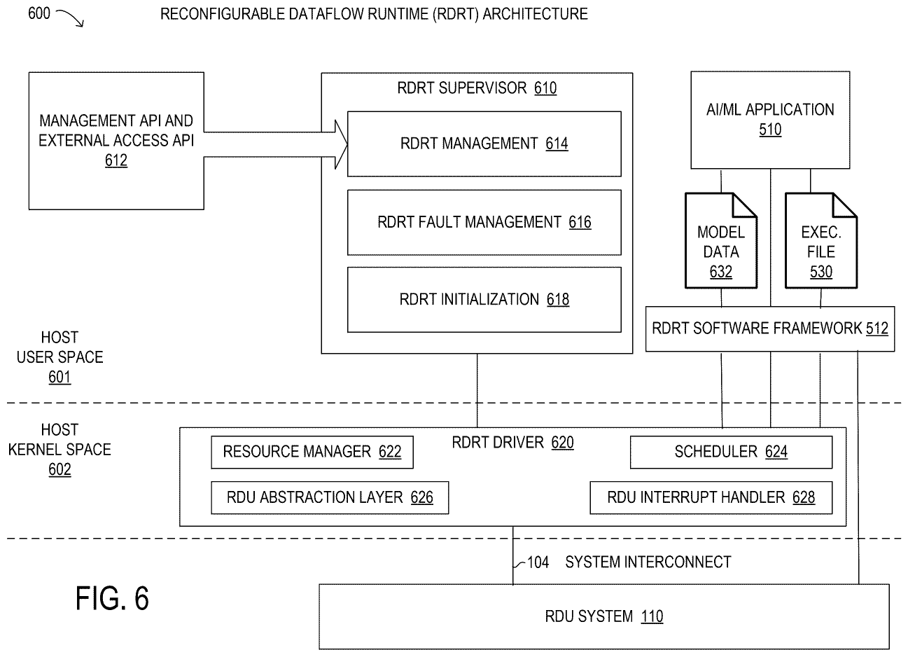

In general terms, reconfigurable dataflow architecture 100, which includes RDRT architecture 600 (see FIG. 6) is capable of managing graph execution and hardware resources of RDU system 110. In particular, reconfigurable dataflow architecture 100 can support data-flow AI/ML applications, such as ML training, low-latency inference, and extract-transform-load (ETL) enterprise processes. As will be described in further detail, reconfigurable dataflow architecture 100 is a modular architecture that is scalable for different types and sizes of workloads. For example, RDU system 110 can be scaled to use any number of RDUs 114, such as from 1 to 1024 or more in various embodiments. Various features and capabilities of reconfigurable dataflow architecture 100, whether in hardware or in software, have been designed and optimized for maximum or optimal compute performance and device memory utilization. In particular, reconfigurable dataflow architecture 100 can provide for efficient data exchange between host 102 and device memory included in RDU system 110, for example, by consuming low overhead of an operating system executing on host 102 during data exchange over system interconnect 104. Additionally, reconfigurable dataflow architecture 100 provides various tools and utilities for orchestration of model execution, including for execution management, debugging, and profiling, among others.

As shown in FIG. 1, network 120 can represent any of a variety of network systems, such a local area network (LAN), a wide area network (WAN) or combinations thereof. Network 120 can include or support wired and wireless network connections. In some embodiments, network 120 can include private network domains or public network domains, such as the Internet, or both public and private network domains. In particular embodiments, network 120 can be optional such that network 120 is not used, or access to network 120 by host 102 is blocked or prevented, in which case host 102 and RDU system 110 can operate privately without network access.

As shown in FIG. 1, host 102 can represent any of a variety of computer systems that can operate using a CPU and a corresponding operating system to enable the execution of software on host 102 using the CPU. In particular embodiments, host 102 can represent at least certain portions of a computer system host 102-2 (see FIG. 3) or a high-performance computer

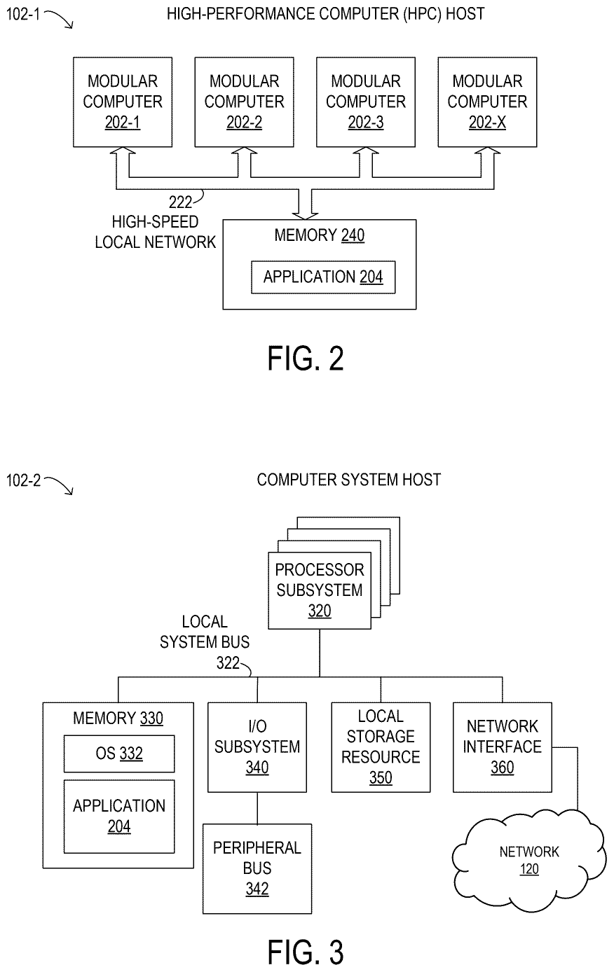

(HPC) host 102-1 (see FIG. 2), as will be discussed in further detail below. The operating system executing on host 102 may enable the execution of software to control RDU system 110, such as by providing a user space for general processing task execution and a kernel space for hardware I/O driver execution (see also FIG. 3), among other tasks or processes. In this manner, RDU system 110 can be exclusively controlled and operated by host 102, as will be described in further detail. Specifically, host 102 can be loaded with various software components and tools to enable development and execution of an application that can be executed using RDU system 110 for accelerated execution. The various software components and tools executing on host 102 can be developed for and integrated with RDU system 110. For example, the various software components and tools used at host 102 to control RDU system 110 can be developed and supplied by a manufacturer of RDU system 110 for the specific purpose of operating RDU system 110.

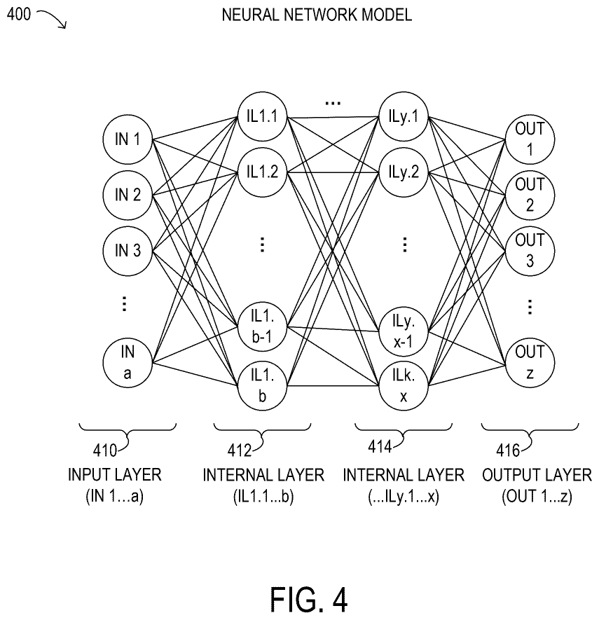

Accordingly, as shown in FIG. 1, RDU system 110 may be capable of operation using the various software components and tools installed at host 102 for controlling and managing RDU system 110. In particular, RDU system 110 may serve as an acceleration platform for executing workloads involving parallel data processing, and in particular, for AI/ML applications. In various embodiments, workloads can include training or inference of a NN model (see also FIG. 4), such as an LLM. Because RDU system 110 does not include various components and associated functionality typically included in a CPU, such as an instruction pipeline and clock, RDU system 110 may be specifically implemented for high-speed processing of various workloads, such as AI/ML applications. Furthermore, RDU system 110 may be capable of operating with lower power consumption for a comparable workload as a CPU or combined CPU/GPU systems, and in particular, for AI/ML applications.

As depicted in FIG. 1, system interconnect 104 can be a primary or unitary connection for communication between host 102 and RDU system 110. In particular embodiments, system interconnect 104 can include a standard interface, such as a peripheral interconnect, an optical interconnect, or a network connection. For example, system interconnect 104 can represent a peripheral interconnect that is compatible with a peripheral component interconnect (PCI) bus standard. In some embodiments, system interconnect 104 can represent a network connection that is compatible with an Ethernet network standard. Furthermore, in particular embodiments, a total data processing throughput capacity of RDU system 110 can be determined based on a data throughput capacity of system interconnect 104 when system interconnect 104 is a singular connection to host 102. In other embodiments, system interconnect 104 can represent multiple parallel connections between host 102 and RDU system 110 that are bundled for increased throughput capacity. Accordingly, in different embodiments, host 102 can be configured to support various implementations of RDU system 110, such as different RDU systems 110 that are dimensioned with different numbers of components and having different overall data processing capacity.

As shown in FIG. 1, system interconnect 104 is communicatively coupled with local interconnect 116 that is used for various internal connections at RDU system 110. In some embodiments, system interconnect 104 and local interconnect 116 can include the same type of interface, such as a PCI bus standard, an optical bus standard, or an Ethernet network standard. In some embodiments, system interconnect 104 and local interconnect 116 can include different types of interfaces, such that a bridge or a bus multiplexer or similar interface conversion device is used between system interconnect 104 and local interconnect 116. Although depicted in FIG. 1 with a singular RDU system 110 having a certain number of internal components, system interconnect 104 may operate with (e.g., be coupled to) different numbers of RDU systems 110 or RDU systems having different numbers of internal components.

In FIG. 1, local interconnect 116 is shown branching to connect various internal components in RDU system 110. Specifically, RDU system 110 is shown including four (4) extensible RDU (xRDU) elements 112 that each include two (2) RDUs 114, of which xRDU element 112-1 having RDU 114-1 and RDU 114-2 are visible. In the exemplary embodiment of RDU system 110 in FIG. 1, xRDU elements 112-2, 112-3, and 112-4 can be identical to xRDU element 112-1. The branching of local interconnect 116 within RDU system 110 may be schematic to represent various bus topologies and distribution arrangements using corresponding additional equipment that is omitted from FIG. 1 for descriptive clarity. Furthermore, local interconnect 116 can further extend within RDU 114 to provide connections to various internal components of RDU 114, as described in further detail herein.

In particular embodiments, RDU system 110 may support so-called “on-board Al” in which an AI/ML model can be executed in the hardware included with RDU system 110 for acceleration of certain computational operations, such as linear algebra or matrix calculations. In particular, RDU system 110 can achieve acceleration factors of 1,000× or 10,000× or greater with respect to other types of processors. RDU system 110 can be specifically implemented to execute mathematical operations related to NN processing, such as linear algebra and tensor operations (including vector and matrix operations). In this manner, RDU system 110 can support large or very large AI/ML models that include NNs having 109 or more neurons with multiple NN layers for complex logic. RDU system 110 can be used, thus, for efficient execution of trained AI/ML models for on-board AI applications.

The linear algebra calculations performed by RDU system 110 can include multiply-accumulate calculations, calculation of bias weights, or calculations of activation functions that may involve relatively simple and repetitive calculations performed at large scale, such as for on-board AI. As noted, in particular implementations, the linear algebra calculations performed by RDU system 110 may be structured as matrix operations and can be executed using simplified compute units configured for parallel execution to improve acceleration, as will be described in further detail. In particular implementations, a large amount of memory can be included with or be accessible to RDU system 110, such as to support larger on-board AI applications, as will be described further below. Furthermore, to enhance acceleration, RDU system 110 may be implemented to support lower precision numerical values, such as involving a smaller number of bits per numerical value, for NN calculations. In particular embodiments, RDU system 110 can support integer values rather than floating point values for improved acceleration.

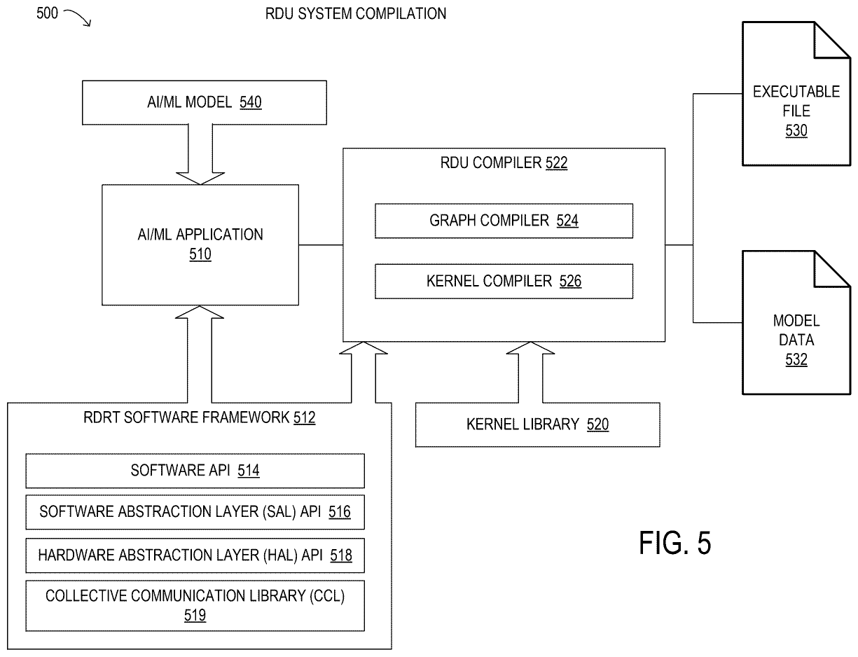

In operation of reconfigurable dataflow architecture 100, an application, such as an AI/ML application, can be prepared at host 102 for execution by RDU system 110. The functionality of the application along with data associated with the application can be configured at host 102 using software applications and tools installed on host 102 for operating RDU system 110. For example, the application can use application specific interface (API) function libraries for accessing hardware functionality within RDU system 110. The APIs may form part of a software development kit (SDK) that includes functions that can be called from the application to access a driver for RDU system 110 executing in kernel mode in an operating system running on host 102. For example, an AI/ML application can be compiled using an RDU compiler 522 (see also FIG. 5) on host 102 to generate an executable file 530 having binary code that is specific to RDU 114, as will be described in further detail. The executable file 530, along with model data 532 that describes a NN for the AI/ML application in some embodiments, can be sent for execution to at least one RDU 114 via local interconnect 116. The output from the NN can then be transferred back to the AI/ML application at host 102 via local interconnect 116. In this manner, RDU system 110 can be used for accelerated execution of the AI/ML application in reconfigurable dataflow architecture 100. The term “reconfigurable” can be indicative of the ability to generate (e.g., compile) executable file 530 that configures hardware in RDU system 110 for executing a particular application (rather than compiling code for execution by a CPU), while the term “dataflow” can be indicative of a parallelized workload, such as the AI/ML application based on the NN, that is driven by input data to generate output data (rather than by a clocked instruction pipeline as in a CPU).

FIG. 2 illustrates a block diagram depiction of a high-performance computer (HPC) host 102-1. In some embodiments, host 102 (see FIG. 1) may be implemented using HPC host 102-1 shown including multiple modular computers 202-1, 202-2, 202-3, 202-4. Although four modular computers 202-1, 202-2, 202-3, 202-4 are shown in FIG. 2 for descriptive purposes, it is noted that any number of modular computers 202 may be used. In particular embodiments, a large number of modular computers 202 may be aggregated in HPC host 200 to provide greater computing capacity. Accordingly workloads, may be executed in a distributed manner in HPC host 200, by implementing multi-node application execution, such that multiple modular computers 202-1, 202-2, 202-3, 202-4 share processing of work tasks that may be performed in a parallel or simultaneous manner.

As shown in FIG. 2, HPC host 200 can be described in general terms as a collection of modular computers 202-1, 202-2, 202-3, 202-4 or any number of computers that respectively include a local processor and local memory and are interconnected by high-speed local network 222, which may be a dedicated high-bandwidth, low-latency network. HPC host 200 can accordingly aggregate and combine the computational power of multiple modular computers 202-1, 202-2, 202-3, 202-4, or any number of modular computers, to perform large-scale work tasks. HPC host 200 can flexibly scale HPC resources that can be matched to desired work tasks. HPC host 200 can also provide configuration for work task parallelization, data distribution, parallel execution, host monitoring and control, as well as supporting parallelized computations having combined output. Various software applications can execute on HPC host 200 in a local or distributed manner, such as on a single modular computer 202-1 or on multiple modular computers with the addition of modular computers 202-2, 202-3, 202-4, or another number of modular computers.

As shown in FIG. 2, HPC host 200 is shown including a memory 240, which may represent one or more memory devices that are compatible with high-speed local network 222. High-speed local network 222 may be a dedicated local bus such as including InfiniBand, 40 Gb Ethernet, or PCIe. Accordingly, memory 240 can provide access to storage resources using low latency high-speed local network 222 to support work tasks handled by HPC host 200. It is further noted that HPC host 200 may include a dedicated network interface that can provide network connectivity by using modular computers 202-1, 202-2, 202-3, 202-4, or another number of modular computers.

In particular embodiments, modular computer 202 in HPC host 102-1 can be an instance of computer system host 102-2 (see FIG. 3) that includes a peripheral bus 342 for use with system interconnect 104 (see FIG. 1). In some embodiments, high-speed local network 222 can be coupled for use with system interconnect 104. In particular, memory 240 is shown storing an application 204 that can be executed, at least in part, using RDU system 110, as described herein with respect to architecture 100.

FIG. 3 illustrates a block diagram depiction of a computer system host 102-2, in accordance with one or more embodiments of this disclosure. Embodiments described herein may be implemented using a computer system, such as computer system host 102-2, in an individual manner or in a cluster of multiple computer systems. Accordingly, computer system host 102-2 may represent any of a variety of computing devices, such as, but not limited to personal computers, desktop computers, laptops, tablets, mobile devices, smart phones, cloud servers, blade computers, microcomputers, embedded devices, or modular computers, among others.

As shown in FIG. 3, computer system host 102-2 includes a processor subsystem 320, a local system bus 322 for interconnecting various local elements, a memory 330, an operating system (OS) 332, an input/output (I/O) subsystem 340, a local storage resource 350, a network interface 360, and network 120.

As shown in FIG. 3, processor subsystem 320 may include an integrated circuit (IC), such as in the form of a semiconductor device that is formed using at least one substrate, such as silicon. Processor subsystem 320 may accordingly be used for interpreting and executing program instructions and processing data that is stored either locally or remotely or both. Processor subsystem 320 may include a central processing unit (CPU) that uses an instruction set architecture to execute instructions, such as, but not limited to an advanced reduced instruction set computer (RISC) machine (ARM) architecture or an x86 architecture.

As shown in FIG. 3, a local system bus 322 may represent a variety of suitable types of bus structures, such as but not limited to a memory bus, a data bus, an address bus, a control bus, or a peripheral bus, among various other examples.

As shown in FIG. 3, memory 330 may include a system, device, or apparatus operable to retain and retrieve processor-executable instructions or data or both, such as for a period of time. Memory 330 may include volatile memory such as RAM, including video RAM (VRAM), static RAM (SRAM), or dynamic RAM (DRAM), cache memory, and non-volatile memory. Memory 330 may include or represent a computer-readable non-transitory medium that includes, but is not limited to portable or non-portable storage devices, optical storage devices, magnetic storage devices, or various other storage media. The processor-executable instructions may include a procedure, a function, a subprogram, a program, a routine, a subroutine, a module, a software package, a data object, a data structure, or a program statement, or various combinations thereof.

As shown in FIG. 3, an OS 332 is stored in memory 330. OS 332 may represent an execution environment for various program code executing on computer system host 102-2. OS 332 may be any of a variety of standard or customized operating systems, such as but not limited to a Microsoft Windows® operating systems, a UNIX or a UNIX-based operating system, a mobile device operating system, an Apple® MacOS or iOS operating system, an embedded operating system, or a hypervisor for executing multiple virtual machines on common hardware, among others. OS 332 can be an operating system that supports shared memory, distributed memory, virtual memory, contiguous or non-contiguous memory allocation, among other memory arrangements. Also shown included with memory 330 is application 204 described above with respect to FIG. 2 and that can represent an AI/ML application for execution on RDU system 110, as described herein.

As shown in FIG. 3, in computer system host 102-2, I/O subsystem 340 may include a system, device, or apparatus generally operable to receive/transmit data to or from or internally within computer system host 102-2. In different embodiments, I/O subsystem 340 may be used to support various peripheral devices or interfaces. I/O subsystem 340 may represent a variety of communication interfaces such as, but not limited to, graphics interfaces, video interfaces, user input interfaces, and peripheral interfaces. I/O subsystem 340 may support various output or display devices, such as but not limited to a screen, a monitor, a general display device, a liquid crystal display (LCD), a plasma display, a touchscreen, a projector, a printer, an external storage device. In particular, I/O subsystem 340 is shown providing peripheral bus 342 that can support system interconnect 104, as described above with respect to FIG. 1.

As shown in FIG. 3, local storage resource 350 may comprise non-volatile or persistent computer-readable media such as a hard disk drive, CD-ROM, and other type of rotating storage media, flash memory, electrically erasable programmable read-only memory (EEPROM), or another type of storage media, and may be generally operable to store instructions and data and to permit access to stored instructions and data on demand. Local storage resource 350 may include a storage appliance or a storage subsystem having one or more arrays of storage devices such as for supporting redundancy, mirroring, or real-time data error correction and restoration.

As shown in FIG. 3, network interface 360 may facilitate connecting computer system host 102-2 to network 120. Network 120 may represent various configurations, such as but not limited to a local area network (LAN), a wide area network (WAN) such as the Internet, or a mobile network, such as a wireless network. Network interface 360 may accordingly include or support wireless networks or wired networks. The wired network media supported by network interface 360 (or included in I/O subsystem 340) may include analog media, universal serial bus (USB), Apple® Lightning®, Ethernet, peripheral connect interface express (PCIe), DisplayPort (DP), Thunderbolt, fiber optics, a proprietary wired media, or an ad-hoc network media, among others. The wireless network media supported by network interface 360 may include or support visible light communication (VLC), worldwide interoperability for microwave access (WiMAX), a Bluetooth® wireless signal transfer, an IBEACON® wireless signal transfer, an radio-frequency identification (RFID) wireless signal transfer, near-field communications (NFC) wireless signal transfer, dedicated short range communication (DSRC) wireless signal transfer, 802.11 WiFi wireless signal transfer, wireless local area network (WLAN) signal transfer, infrared (IR) communication wireless signal transfer, global navigation satellite system (GNSS), global system for mobile communication (GSM), such as 3G/4G/5G/LTE cellular data network wireless signal transfer, radio wave signal transfer, microwave signal transfer, infrared signal transfer, visible light signal transfer, ultraviolet light signal transfer, or more generally, various kinds of wireless signal transfer along using radiation in a wavelength range of the electromagnetic spectrum.

FIG. 4 depicts an NN model 400 in one embodiment. NN model 400 is depicted as a neural network architecture having an input layer 410, internal layers 412, 414, and an output layer 416. In particular embodiments, implementation and use of NN model 400 may be performed using RDU system 110, as described herein. For example, executable file 530 can be compiled to configure and operate RDU system 110 to implement NN model 400 in various embodiments. In some embodiments, model data 532 can also be sent to RDU system 110 for this purpose (see FIG. 5).

In the mathematical processing of NN model 400 of FIG. 4, the processing at each layer can be represented by an activation function that can be generalized by Equation 1.

$$y = {\sum }_{l} ( {w}_{i} {x}_{i} ) + b \qquad Equation 1$$

In Equation 1, y is an output value, i represents an index variable or dimension for each layer input, such as a, b. x, and z in FIG. 4; xᵢ represents the input value at each neuron, such as from another neuron; wᵢ represents a weighting coefficient applied at each neuron; and b represents a constant for each neuron. The output of each neuron can be represented by output value y of Equation 1, among other parameters in particular embodiments.

The process of activation of each internal layer as described above and illustrated in FIG. 4 is generally known as feedforward activation, which characterizes the typical use of a neural network to receive input and generate output. Feedforward may occur over multiple timesteps and may involve the use of externally generated data that are referred to as “tokens”, internally generated data, or both. The use of feedforward activation within NN model 400 to generate output (separate from feedback, backpropagation, and other types of training) is also known as “inference”.

It is noted that although NN model 400 is depicted with a certain set of nodes or artificial neurons (referred to herein as simply “neurons”) in FIG. 4, the dimensionality and structure of NN model 400 can be adapted for various specific types of data and applications. For example, as shown, NN model 400 can be expanded to a number of input neurons, w number of input layers each having b through x number of neurons respectively, and z number of output neurons. It is noted that a, b through x, w, and z can each have different dimensions, such as 103, 106, 109, 1012, among other values in various embodiments. Furthermore, although a single network is shown with NN model 400 in FIG. 4, it is noted that in different implementations, NN model 400 can be structured to incorporate different numbers of networks, such as by implementing a branched or otherwise structured topology.

In order to implement NN model 400 for a given useful application, a training process can be employed to determine respective weighting coefficients applied at each neuron, such as using Equation 1 or another activation function. For example, weighting coefficients associated with neurons in NN model 400 can be represented as a 2-D tensor (e.g., a matrix) that are included in model data 532 as explained in further detail below.

In the field of NNs and ML, optimization algorithms can be useful for training models by minimizing the error between the predicted output and target values. One known class of optimization algorithms are gradient descent algorithms. Gradient descent can be an iterative optimization algorithm used to minimize a “cost function” (also referred to as a “loss function”), which quantifies an error or a difference between an ML model's prediction and a target value (e.g., a known reference value). The gradient descent can operate by adjusting the parameters of the NN to reduce the error over multiple iterations.

To identify a direction and a magnitude by which model parameters are to be updated, gradients represented by partial derivative of a given model parameter with respect to the cost function, can be computed. For typical feedforward NNs, as shown in NN model 400, the computation of the gradients can be done using so called “backpropagation”, which involves a reverse application of a chain rule to propagate the gradient of the loss function backwards through the NN. In particular embodiments, backpropagation may be used to iteratively train NN model 400, such as by using RDU system 110. For example, the calculated output of NN model 400 may be represented by output data while the reference output may be represented by validation data. The backpropagation method may begin with output layer 416 and then iterate in a reverse manner over internal layer 414, then internal layer 412, to finally arrive at input layer 410.

Because most useful NN models have large numbers of inputs and outputs, backpropagation can be resource-intensive. While the calculation of the cost function itself can be relatively simple and fast, calculation of the gradients with respect to the cost function is generally more resource intensive. For some NN models, the runtime of each backpropagation for training may be greater than the feedforward activation for inference. Accordingly, reconfigurable data flow architecture 100 shown in FIG. 1, and as described herein, can provide acceleration of computations, such as in backpropagation for training or feedforward activation for training, which is desirable.

FIG. 5 is a block diagram of an RDU system compilation 500, in one embodiment. FIG. 5 is a schematic illustration of a process describing RDU system compilation 500, in one exemplary embodiment. It is noted that various other elements or different arrangements of RDU system compilation 500 can be used or performed in different embodiments.

As shown in FIG. 5, RDU system compilation 500 includes an AI/ML application 510 and an RDU compiler 522 that can represent different software applications capable of execution on host 102. In particular, AI/ML application 510 and RDU compiler 522 can be executed in a host user space 601 within an operating system executing on host 102, such as OS 332 (see also FIGS. 3 and 6). AI/ML application 510 can represent at least some software functionality defined by a user of reconfigurable data flow architecture 100 for execution using RDU system 110. For example, AI/ML application may be developed or programmed by the user (or on behalf of the user) using various tools and software routines, as noted above. Specifically, API function libraries for accessing hardware functionality within RDU system 110 can be provided as an RDRT software framework 512. The functions in API function libraries of RDRT software framework 512 can be integrated into the code of AI/ML application 510 or RDU compiler 522, as shown in FIG. 5, to provide runtime access to commensurate functionality performed by an RDRT driver 620 executing in a host kernel space 602 (see FIG. 6) within the operating system executing on host 102.

In FIGS. 5 and 6, various external function libraries and data structures are shown with arrowed boxes indicating contribution of code elements directed to a software application. For example, the code elements, such as API function libraries, can be integrated into the software element during development or programming, and then can be compiled into an executable form of the application. In some cases, code elements can be added or integrated as options or features in an application level tool.

In FIG. 5, an AI/ML model 540 and RDRT software framework 512 are shown contributing to the source code of AI/ML application 510 in this manner. Specifically, AI/ML model 540 may represent a NN-based model, such as an LLM, that the user of reconfigurable dataflow architecture 100 seeks to implement and run using RDU system 110, and for which purpose AI/ML application 510 is developed, including specific support for hardware features of RDU system 110. Accordingly, AI/ML model 540 can be provided by the user, or on behalf of the user, in various embodiments. It is noted that AI/ML model 540 may represent a local or remote source of data describing or defining the NN-based model, such as NN model 400 (see FIG. 4), which may be defined using a 2-D tensor of weighting coefficients (wᵢ), for example, among other values.

As shown in FIG. 5, RDRT software framework 512 comprises various API function libraries, including a software API 514, a software abstraction layer (SAL) API 516, a hardware abstraction layer (HAL) API 518, and a collective communication library (CCL) 519. The API function libraries (514, 516, 518, 519) included with RDRT software framework 512 can define a so-called “application stack” using the system-level function libraries that allow the user to run AI/ML model 540 on RDU system 110. The application stack can accordingly be implemented for a specific user application as AI/ML application 510. In particular, CCL 519 can be used for orchestration and coordination of the data-parallel execution of AI/ML model 540 using RDU system 110. In particular, CCL 519 can support non-blocking and standard-mode blocking of P2P communications among RDUs 114, persistent communication requests, as well as allowing AI/ML application 510 to directly access device memory on RDU 114, for example, to eliminate a redundant copy of memory contents at host 102. In particular, CCL 519 may provide a transport layer that supports different interfaces for system interconnect 104, such as to accelerate memory transfers between different RDUs 114, such as by supporting remote direct memory access (RDMA). For example, CCL 519 may support or select among various available interfaces, such as PCIe, RDMA over Converged Ethernet (ROCE), or InfiniBand, among others.

Also in RDU system compilation 500 is RDU compiler 522 that represents another software tool executable at host 102 to generate executable file 530 and model data 532 that are compiled into a format that is specific for RDU system 110. In particular, executable file 530 and model data 532 can be used to execute AI/ML model 540 on RDU system 110, as also defined or specified by AI/ML application 510. In some embodiments, such as when using RDU system 110 to implement externally developed AI/ML models, external model data instead of model data 532 can be used. In particular embodiments, RDU compiler 522 can itself be comprised of functional libraries and routines that are invoked using RDRT software framework 512 as a development environment for implementing AI/ML model 540. In various embodiments, RDRT software framework 512 can also be used to develop AI/ML application 510. Accordingly, RDRT software framework 512 can perform model graph tracing, invoking RDU compiler 522, and orchestrating execution of AI/ML model 540. A selection of RDRT software framework 512 can depend on a hardware or operating system environment used for host 102. Some examples of software platforms that can be used for RDRT software framework 512 include PyTorch or TensorFlow, among others.

As shown in FIG. 5, a kernel library 520 may include a set of operator kernels that supports both a graph compiler 524 a kernel compiler 526 that comprise RDU compiler 522. In particular, kernel library 520 can be specifically optimized for RDU system 110. Graph compiler 524 may be responsible for model-level graph transformation and various optimizations in this regard. For example, graph compiler 524 may transform or convert a model graph of AI/ML model 540 into compiled RDU kernel graphs and execution schedules included with model data 532 for execution on RDU system 110. Similarly, kernel compiler 526 may transform the RDU kernel graphs into executable file 530 that is specific for RDU system 110 as the execution target.

FIG. 6 is a block diagram of an RDRT architecture 600, in one embodiment. FIG. 6 is a schematic illustration of a post-compilation runtime process for executing AI/ML model 540, represented in FIG. 6 by executable file 530 and a model data 632, on RDU system 110 in one exemplary embodiment. It is noted that various other elements or different arrangements of RDRT architecture 600 can be used in different embodiments.

In FIG. 6, RDRT architecture 600 comprises an RDRT supervisor 610, AI/ML application 510, and RDRT software framework 512 that are software applications or modules executing in host user space 601 on host 102. RDRT architecture 600 also comprises an RDRT driver 620 executing as a kernel service in host kernel space 602 on host 102. RDRT driver 620 is further shown as a logical endpoint of system interconnect 104 to RDU system 110. RDRT driver 620 may control and manage system interconnect 104, including managing a host memory space associated with system interconnect 104 as well as direct memory access (DMA) transfers via system interconnect 104. In various embodiments, RDRT software framework 512 may directly communicate with RDU system 110 such as for various hardware and software configuration purposes. Accordingly, as given in RDRT architecture 600, RDRT driver 620 and RDRT software framework 512 may perform or enable various tasks associated with configuring and orchestrating execution of executable file 530 and model data 632 on RDU system 110.

In some embodiments, at least certain portions of RDRT driver 620 (or an equivalent module) may be executed in host user space 601, instead of host kernel space 602. For example, a kernel driver for system interconnect 104 may be used, such that other functionality shown with RDRT driver 620 can operate in host user space 601.

As shown in FIG. 6, model data 632 can represent model data 532 generated by RDU compiler 522, or external model data from an external source in some embodiments. For example, RDRT driver 620 may provide a graph finite state machine (FSM) and handle data transfer to RDU system 110. Additionally, RDRT driver 620 may access control/status registers (CSR) on RDU system 110 to interact with, monitor, and control various actions, such as by reading or writing a particular CSR for a particular purpose.

As shown in FIG. 6, RDRT driver 620 includes various modules including a resource manager 622, a scheduler 624, an RDU abstraction layer 626, and an RDU interrupt handler 628. Resource manager 622 may coordinate and allocate hardware resources on RDU system 110 with respect to workloads for a given AI/ML application 510. Scheduler 624 may represent software-based scheduling of processing tasks on RDU system 110 (in contrast to local hardware scheduling in RDU system 110).

In FIG. 6, RDRT supervisor 610 can be a user operated application that handles fault management and initialization during runtime, among other tasks, on RDU system 110. Accordingly, RDRT supervisor 610 is shown including RDRT management 614 that can integrate functions and features from management API and external access API 612 for the user, among other monitoring and control functions for RDU system 110. RDRT management 614 can accordingly be used to programmatically request information about RDU status, manage RDUs, and retrieve information about host 102. RDRT fault management 616 includes a framework that supports reporting, diagnosing, and analyzing system error and fault events associated with RDU system 110, including reporting, logging, and clearing faults, among other actions. RDRT initialization 618 includes functionality for initializing hardware components in RDU system 110 prior to runtime, such as upon startup, in order to place the hardware components in a desired operational state or condition. RDU interrupt handler 628 may include subroutines that can be triggered in response to one or more interrupts that are generated by RDU 114. For example, RDU interrupt handler 628 may report interrupts to RDRT supervisor 610 for further handling and processing.

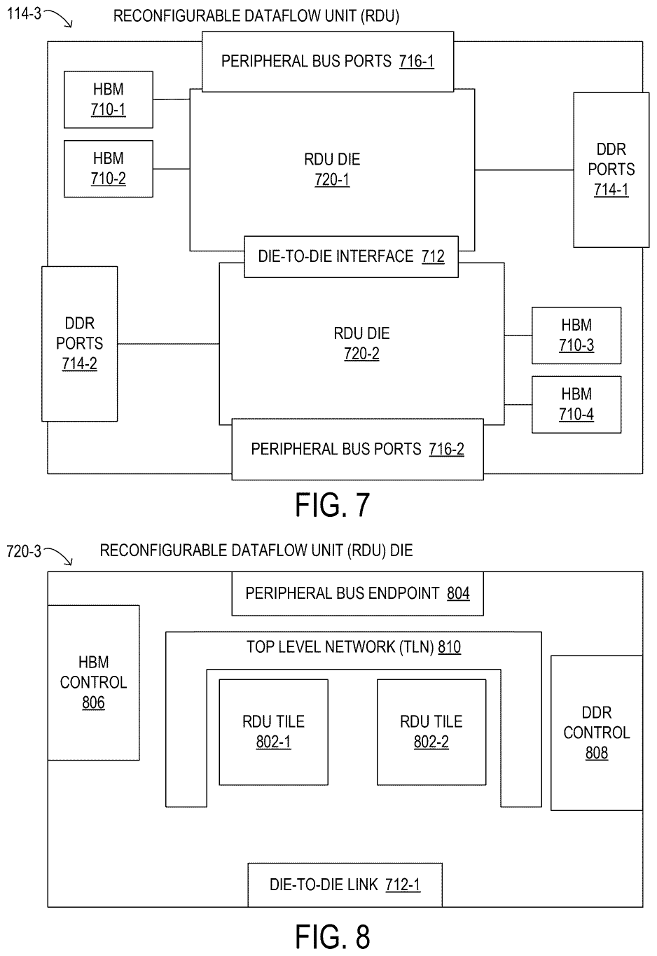

In FIGS. 7, 8, and 9, various internal components of RDU 114 included with xRDU element 112 are shown (see FIG. 1). FIGS. 7, 8, and 9 are schematic illustrations and are not necessarily drawn to scale or perspective. It is also noted that in FIGS. 7, 8, and 9, various components are depicted and described below, while various other details, such as connection traces, power routing elements, and various circuit details are omitted for descriptive clarity. In particular, various communication links that provide communicative and signaling functionality among depicted components in FIGS. 7, 8, and 9 are omitted for descriptive clarity. In some embodiments, different components can be included with RDU 114 than depicted in the exemplary embodiments of FIGS. 7, 8, and 9 presented for descriptive purposes.

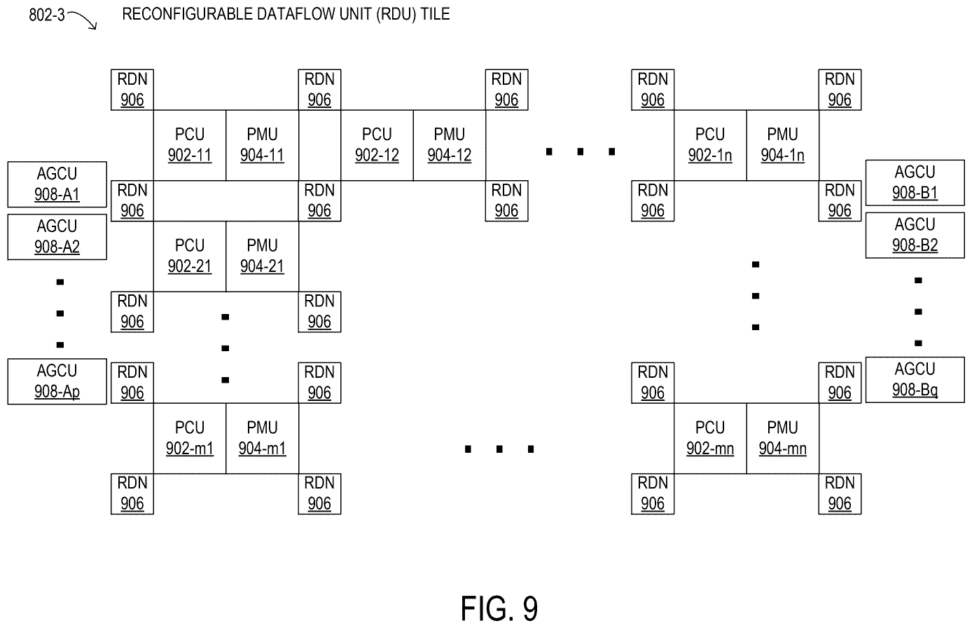

As noted above, in the exemplary embodiment of reconfigurable dataflow architecture 100 in FIG. 1, xRDU element 112-1 is depicted as being populated with two (2) RDUs 114-1, 114-2, each of which being coupled to local interconnect 116. It is noted that the arrangement depicted in FIG. 1 is an example for descriptive purposes and that different numbers of RDUs 114 may be integrated into xRDU element 112 in different embodiments. FIG. 7 depicts an exemplary embodiment of RDU 114-3; FIG. 8 depicts an exemplary embodiment of an RDU die 720-3; FIG. 9 depicts an exemplary embodiment of an RDU tile 802-3.

FIG. 7 is a block diagram of RDU 114-3, in one embodiment. In particular embodiments, RDU 114-3 can be packaged as a dual die socket using chip-on-wafer-on-substrate (CoWoS) multi-chip packaging. As shown, RDU 114-3 includes two RDU die 720-1, 720-2 that are coupled together with a die-to-die (D2D) interface 712. RDU 114-3 also includes two banks of peripheral bus ports 716 that provide various internal and external connections for each RDU die 720, respectively. Specifically, peripheral bus port 716-1 is accessible to RDU die 720-1, while peripheral bus port 716-2 is accessible to RDU die 720-2. In some embodiments, peripheral bus port 716 can provide a host interface via local interconnect 116, as well as multiple internal peer-to-peer (P2P) links to other RDUs 114 in RDU system 110. The host interface at peripheral bus port 716 can be coupled to, or form a portion of local interconnect 116 (see FIG. 1) and further be coupled to host 102 via system interconnect 104. In this manner, system interconnect 104 and local interconnect 116 can provide direct memory access (DMA) over the host interface between host memory (such as memory 330, see FIG. 3) and HBM 710 or DDR memory (not shown), as well as direct communication between host 102 and RDU tile 802. Additionally, each RDU die 720 is coupled to two (2) high bandwidth memories (HBM) 710 and at least one double data rate (DDR) memory port 714 that supports external DDR memory (not shown). Specifically, RDU die 720-1 is coupled to HBM 710-1 and HBM 710-2, along with DDR memory ports 714-1, while RDU die 720-2 is coupled to HBM 710-3 and HBM 710-4, along with DDR memory ports 714-2. As will be described in further detail, RDU die 720 includes multiple pattern compute units (PCU) 902 and pattern memory units (PMU) 904 (see FIG. 9) for executing parallelized workloads.

Accordingly, a three tier memory architecture implemented in RDU 114-3 includes PMU 904 (not visible in FIG. 7, see FIG. 9), HBM 710, and DDR memory ports 714, which is desirable. In particular embodiments, HBM 710 can have a capacity of 64 GB with a throughput bandwidth of at least 1.8 TB/s, while DDR memory port 714 can support a capacity of 1.5 TB with a throughput bandwidth of at least 200 GB/s. In particular embodiments, HBM 710 and DDR memory port 714 can be managed by software, such as by using RDRT driver 620 at host 102.

FIG. 8 is a block diagram of RDU die 720-3, in one embodiment. As shown, RDU die 720-3 includes a peripheral bus endpoint 804 that can represent an endpoint of peripheral bus ports 716. RDU die 720-3 also includes D2D interface 712-1 that represents one endpoint of D2D interface 712. D2D interface 712 can enable components in RDU tile 802 to stream data between two RDU die 720, such as between RDU die 720-1 and 720-2 in FIG. 7, in a direct manner that may be independent of external memory, such as HBM 710 and DDR memory (not shown). RDU die 720-3 is further shown including an HBM control 806 for interfacing to HBM 710, as well as DDR controller 808 for interfacing with DDR memory ports 714 that support external DDR memory (not shown).

In FIG. 8, RDU die 720-3 is also shown including two (2) RDU tiles 802 that represent dataflow cores performing the core computing operations in RDU system 110, and further include an array of PCUs 902 and PMUs 904, described in further detail below with respect to FIG. 9. Specifically, RDU tile 802-1 and RDU tile 802-2 are provided with a top-level network (TLN) 810 that interfaces with RDU tiles 802 and handle parallelized data throughput to and from RDU tiles 802, such as between RDU tile 802 and host 102, HBM 710, DDR memory ports 714, as well as P2P links to other RDUs 114 via peripheral bus ports 716.

FIG. 9 is a block diagram of RDU tile 802-3, in one embodiment. In particular embodiments, as shown in FIG. 8, RDU die 720 includes two (2) RDU tiles 802. However, in various implementations, different number of RDU tiles 802 can be included in RDU die 720. In FIG. 9, RDU tile 802-3 may represent a coarse-grained reconfigurable array (CGRA) of dataflow cores that each include a pattern compute unit (PCU) 902 coupled with a pattern memory unit (PMU) 904. In addition, RDU tile 802-3 includes multiple address generation and coalescing units (AGCUs) 908 that may be connected together in a two-dimensional (2D) mesh interconnect, referred to as a reconfigurable dataflow network (RDN) 906.

Specifically, as shown in FIG. 9, the array of dataflow cores is shown comprising the 2D mesh array in RDU tile 802-3 is comprised of array elements having one PCU 902 coupled with one PMU 904. In FIG. 9, RDU tile 802-3 is shown having a first array element PCU 902-11/PMU 904-11 at a top left corner. A first row of array elements in RDU tile 802-3 includes PCU 902-12/PMU 904-12 in a second column, and further array elements, up to PCU 903-1n/PMU 904-1n for n number of columns. A first column of array elements in RDU tile 802-3 includes PCU 902-21/PMU 904-21 in a second row, and further array elements, up to PCU 903-m1/PMU 904-m1 for m number of rows. A last array element in RDU tile 802-3 PCU 902-mn/PMU 904-mn is at a bottom right corner in FIG. 9. Also in RDU 802-3, RDN 906 is depicted as a plurality of switching elements at each corner of each individual array element that together represent the 2D mesh interconnect, where each RDN 906 switching element can connect to adjacent elements orthogonally and diagonally. Furthermore, the 2D mesh interconnect collectively represented by RDN 906 in FIG. 9 can connect externally to RDU tile 802-3 with TLN 810, as noted above.

In FIG. 9, AGCUs 908 are shown in two columns at the left and at the right. A first column is shown including AGCU 908-A1, AGCU 908-A2, up to AGCU 908-Ap for p number of AGCUs in the first column. A second column is shown including AGCU 908-B1, AGCU 908-B2, up to AGCU 908-Bq for q number of AGCUs in the second column. In particular embodiments, p and q can be different integers, or can be equal in some cases.

In operation of RDU tile 802-3, PCUs 902 can provide systolic and streaming compute capabilities. A datapath of PCUs 902 can include a header, a body, and a tail. The header of PCUs 902 can consume incoming dataflows and can drive the body. The body of PCUs 902 can be configurable as an output stationary systolic array or as a pipelined single-instruction-multiple-data (SIMD) core with multiple stages of vector compute. The tail of PCUs 902 can perform special element-wise functions and can populate a number of output first-in-first-out (FIFO) buffers included with PCU 902. The PCUs 902 datapath can accordingly perform efficient execution of general matrix multiply (GEMM) or similar operations, element-wise operations, or reductions.

In operation, PCUs 902 can function as either a 2D systolic array or as a SIMD core. The 2D systolic array can accelerate matrix multiplications, such as GEMM. Inputs to the 2D systolic array may be streamed left-to-right and top-to-bottom (as shown in FIG. 9) through a broadcast buffer. Accumulated results can be drained left-to-right to output FIFOs through the tail of PCUs 902. Matrix multiplication can be parallelized further across multiple PCUs 902. As a SIMD core, PCUs 902 can execute a parallel multidimensional tensor operation in a pipelined manner. Each SIMD stage can support common arithmetic, logical, and bit-wise operations in various numerical representations and precision, such as FP32, BF16, and INT32 formats. In addition, PCUs 902 can be optionally configured to implement a cross-lane reduction network. Lane-wise reductions can also be supported by PCUs 902 in a typical SIMD manner. PCUs 902 can include certain counters that track loop iterations and generate control events, such as when a counter reaches a programmed maximum value, indicating that a loop has completed execution, for example.

The tail of PCUs 902 can support transcendental functions, random number generation, stochastic rounding, and format conversions. An operation at the tail can be fused and pipelined with a compute operation in the body of PCUs 902. An operation can be parallelized across multiple PCUs 902 in a data parallel, tensor parallel, or pipeline parallel fashion. Data parallelism may be achieved by partitioning inputs and outputs to RDU tile 802 to create multiple independent data streams that can be processed by different PCUs 902. Tensor parallelism may be achieved by forking into data parallel streams, then joining such data parallel streams. Pipeline parallelism can be achieved by chaining multiple PCUs 902 together to fuse operations and increase operational intensity.

In RDU tile 802-3, PMUs 904 can provide on-chip memory capacity, throughput bandwidth, and addressing flexibility for efficient operator fusion. PMUs 904 an be used to store on-chip tensors like inputs, parameters, metadata, and intermediate results. In particular embodiments, PMU 904 can include the following components:
Scratchpad memory: Each PMU 904 may contain a programmer-managed scratchpad memory that can include a static random access memory (SRAM) array. The SRAM array used for the scratchpad memory may collectively support concurrent writes and reads.
Arithmetic logic unit (ALU) pipeline: PMU 904 may contain several stages of scalar integer ALUs that can be configured to generate read and write addresses concurrently to flexibly access a tensor in the scratchpad memory. PMU ALUs may implement a set of special complex instructions, such as bitfield extraction and shift-and-set, that may often be used in address computations. This instruction support may produce complex addresses efficiently and allow for reducing a number of ALU stages, thereby also reducing latency. The ALU pipeline can also include a path to ingest scalars as operands from RDN 906, and output computed values as scalars back to RDN 906. The ALU pipeline path can allow enhanced addressing composability. For example, complex integer calculations can be broken up and mapped across several PMUs 904 as desired. It has been observed that stage buffers in a spatially fused kernel involve concurrent reads and writes, which may have different access patterns. Certain intermittent scenarios have been observed in write and read access patterns for a tensor that inversely affect each access pattern's complexity (e.g., a relatively complex write access pattern often enables a relatively simpler read access pattern and vice versa). The ALU pipeline can allow software to exploit this observed behavior in write and read access patterns. For example, in some embodiments, the ALU pipeline can be partitioned into independent read and write address generation pipelines with a software-configured number of stages allocated to each type of access.
Address predication and banking: It has been shown that a single logical tensor can span multiple PMUs 904 due to capacity, throughput bandwidth, or both. PMU 904 can enable spanning a tensor over multiple PMUs 904 by providing hooks to programmatically control tensor address interleaving across PMUs. Specifically, PMU 904 can be programmed with a range of valid addresses for one instance of PMU 904. Alternatively, PMU 904 can support a programmable predicate bit per generated address. An address may accordingly be processed by PMU 904 if the address is within a programmed range or a valid predicate; otherwise the address may be dropped by PMU 904. Furthermore, addresses can be mapped to scratchpad banks using bank bit locations that can be programmed by software.
Data alignment unit: A data alignment unit in PMU 904 MAY support common tensor transformation operations, such as transpose, cross-lane vector permute, vector-unaligned accesses, lookup table (LUT), data format, and data layout conversions. Tensors to be transposed can be written in a special diagonally striped format across the scratchpad banks that enables reading the same tensor in both regular and transposed format at full bandwidth, which may allow for implementing the transpose operator as a read-write access pattern optimization between graph buffers.

As shown in FIG. 9, RDN 906 is a programmable interconnect on RDU tile 802 that facilitates communication between PCUs 902, PMUs 904, and AGCUs 908. RDN 906 can comprise three physical fabrics: a vector fabric, a scalar fabric, and a control fabric. The vector fabric and the scalar fabric can be packet-switched. The control fabric can be circuit-switched and can include a bundle of single bit wires that can be individually routed. The vector fabric can serve as a primary conduit for tensor data. The scalar fabric be used to transport metadata, such as an address, but in some cases can also be used to carry data or control signals. The control fabric can be used to carry control tokens for distributed coarse-grain flow control, and to collectively orchestrate the execution of a graph. Control tokens typically correspond to counter ‘done’ events that indicate the end of a loop. RDN 906 may be implemented using a mesh of non-blocking switches, as indicated by the blocks labeled RDN 906 in FIG. 9. Inbound scalar and vector packets to PCU 902/PMU 904 from RDN 906 may arrive via input FIFOs, and leave via output FIFOs. Transmissions on the vector fabric and the scalar fabric may be subject to credit-based flow control at every hop. Packet streams may also be subject to end-to-end flow control between communicating PCU 902/PMU 904 on RDN 906 through a combination of coarse-grained software tokens, fine-grained hardware credits, and forward progress guarantees in hardware. Routing tables for the vector fabric, the scalar fabric, and the control fabric may be configured by software using a place-and-route (PnR) layer within RDU compiler 522.

RDN 906 may support different types of communication patterns, including multi-cast and programmable routing and many-to-one and data reordering.
Multi-cast and programmable routing: Routing of packets on the scalar fabric and the vector fabric of RDN 906 can be done either dynamically using a 2-D dimension order route or as software-controlled static flow routing. In static flow routing, software assigns a flow ID field to a packet stream, which is carried with the packet. The flow ID field is decoded at every switch port and reassigned prior to forwarding the packet to its next destination. The static flow routing mechanism supports packet multi-casting through the switches of RDN 906.
Many-to-one and data reordering: Vector packets can contain a metadata field called sequence ID, which can be a mechanism to support arbitrary many-to-one streams in RDU tile 802. Vector output ports of PCU 902/PMU 904 can be equipped with programmable logic to generate sequence IDs for each output vector. In this manner, sequence IDs can be programmed by software to represent the logical vector order for a given operation across multiple sources. The sequence ID field can be used as an input operand in PMU 904 to compute the write addresses to reorder the packets.

As shown in FIG. 9, AGCU 908 can serve as a reconfigurable dataflow bridge for RDU tile 802 to access local device memory (HBM 710/DDR port 714), host memory 240/330, remote RDU device memory, and remote RDU tiles 802 via TLN 810. On the tile-side, AGCU 908 can operate as a dataflow core by exposing vector, scalar, and control ports of RDN 906. On the TLN-side, AGCU 908 can generate read and write requests and coalesce the responses. AGCU 908 may be equipped with a scalar address generation pipeline and counters, bearing some similarities to the logic of PMU 904, yet without having the SRAM of PMU 904. AGCU 908 can also provide an address translation layer for memory management.
P2P: AGCU 908 can support a P2P communication protocol to directly stream data between RDU tiles 802 on different instances of RDU 114 without involving DDR ports 714 or HBM 710. The P2P protocol can provide for building collective communication primitives between RDUs 114.
Kernel launch orchestration: AGCU 908 may implement a kernel launch mechanism that can include a sequence of three commands: Program Load, Argument Load, and Kernel Execute. Running a model may involves executing a schedule of kernel launches, which can be software-orchestrated or hardware-orchestrated. Software orchestration of the kernel launches may allow more flexible scheduling of kernels and can provide more host software visibility into model execution. However, software orchestration might incur overheads that can impact performance. Hardware orchestration offloads a static kernel schedule to the dedicated hardware in AGCUs 908, which can significantly reduce overhead but might be less flexible than software orchestration.

As explained in further detail, reconfigurable dataflow architecture 100, as described herein, can be used for hardware monitoring and management and hardware fault detection and recovery. For both hardware monitoring and management and hardware fault detection and recovery, an RDU state buffer can be maintained by RDRT architecture 600, such as in memory 240 or 330 on host 102, either in host user space 601 or host kernel space 602, in various embodiments. As noted, the hardware monitoring and management disclosed herein can facilitate recovery for certain operational conditions, including faults, using software commands to access RDU resources that remain responsive and can enable recovery to a ready state. The hardware fault detection and recovery disclosed herein can facilitate detection and recovery when a particular RDU resource is in a hung state and is no longer directly responsive to such software commands, and can enable recovery to a ready state using predetermined procedures provided in the design of RDU 114.

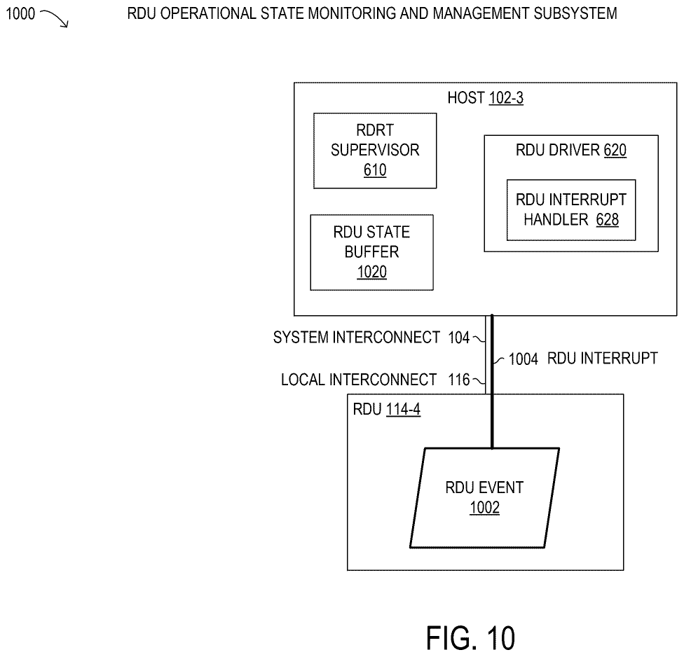

Referring now to FIG. 10, an RDU operational state monitoring and management subsystem 1000 (also referred to simply as “RDU subsystem” 1000) is shown in block diagram format. It is noted that RDU subsystem 1000 in FIG. 10 is a schematic illustration and is not necessarily drawn to scale or perspective. Specifically, RDU subsystem 1000 is shown including host 102-3 coupled to RDU 144-4 using local interconnect 116 and system interconnect 104, as described previously (see FIG. 1).

Also depicted in RDU subsystem 1000 in FIG. 10 are RDRT supervisor 610 and RDU driver 620 that represent software modules in RDRT architecture 600 that can be involved with hardware monitoring and management and hardware fault detection and recovery, as disclosed herein. Furthermore, RDU driver 620 is shown in RDU subsystem 1000 including RDU interrupt handler 628 as mentioned previously (see FIG. 6). Also shown in host 102-3 in RDU subsystem 1000 is an RDU state buffer 1020 that represents state data allocated in a memory 240, 330 of host 102-3 in particular embodiments. Accordingly, RDRT supervisor 610 and RDU driver 620 may access RDU state buffer 1020 for various purposes associated with hardware monitoring and management and hardware fault detection and recovery, as disclosed herein, and as explained in further detail below for certain embodiments. It is noted that any one or more of RDRT supervisor 610, RDU driver 620, or RDU state buffer 1020 may be implemented in either host user space 601 or host kernel space 602 or partially in both, in various embodiments.

Also shown in RDU subsystem 1000 is an RDU event 1002 that generates an RDU interrupt 1004 from RDU 114-4. RDU event 1002 and RDU interrupt 1004 represent runtime events and actions associated with RDU 114-4, such as generated in response to some operational condition, such as an error or a fault. In various embodiments, RDU interrupt 1004 may be received and handled by RDU interrupt handler 628, which may perform interrupt handling in a separate flow from RDU driver 620, such as in an asynchronous manner.

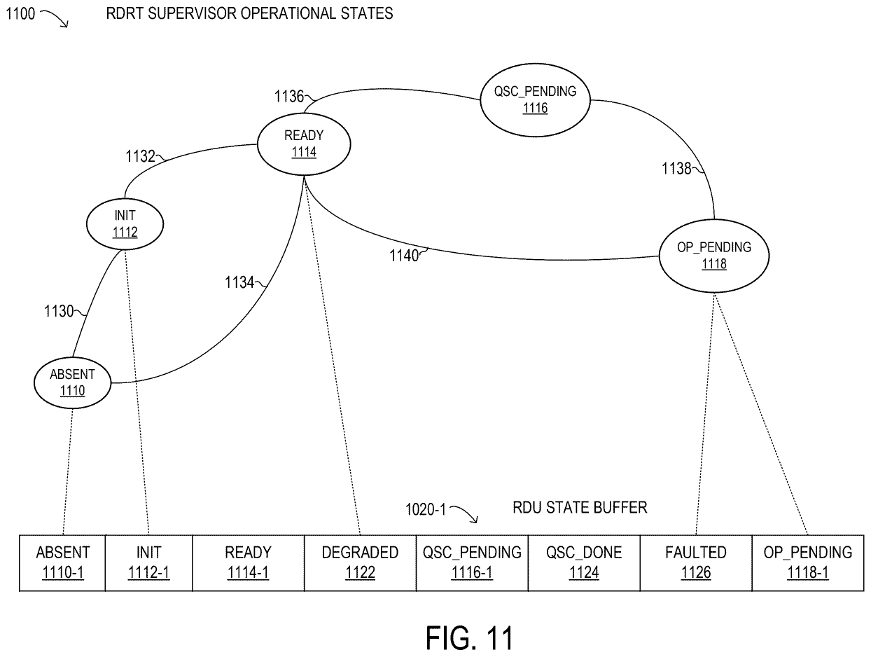

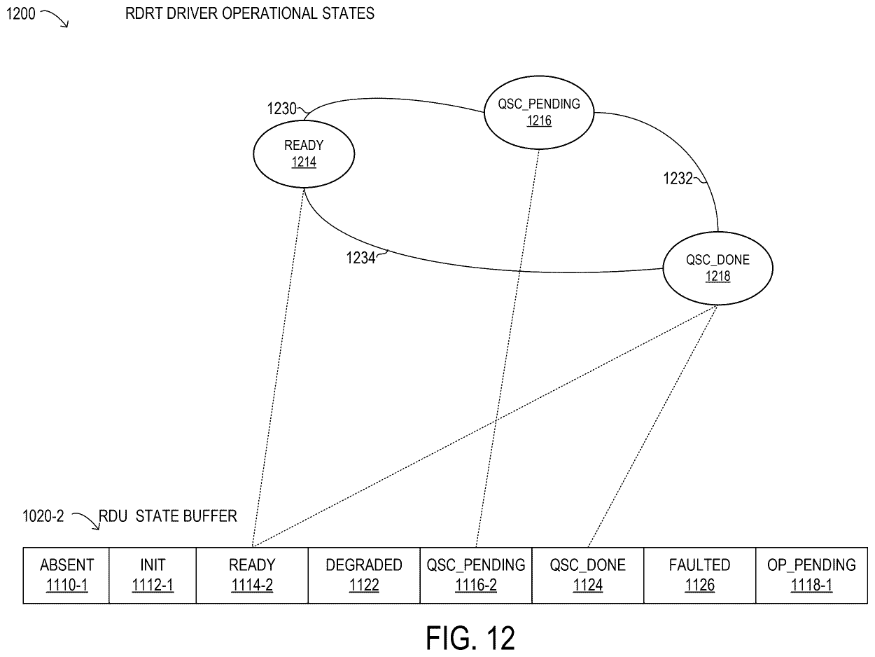

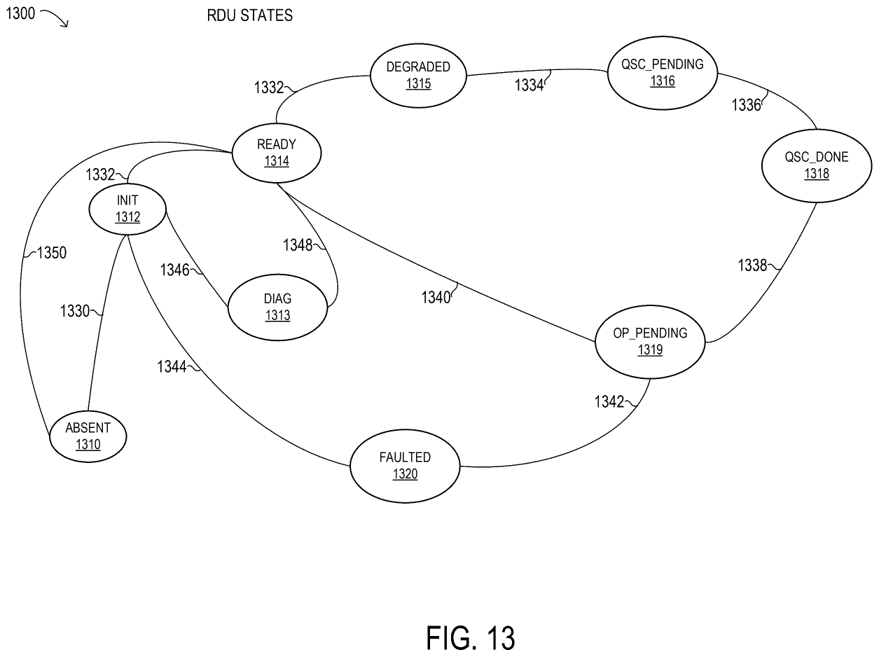

In operation of RDU subsystem 1000, RDRT supervisor 610 and RDU driver 620 may function in a coordinated manner to handle faults in RDU 114-4 and to maintain and update RDU state buffer 1020, as will be explained with respect to FIGS. 11 and 12. A cumulative description of RDU state buffer 1020 with respect to RDU 114 is shown and explained with respect to FIG. 13. In particular, RDU state buffer 1020 may be used for various operational states of RDU 114 that remain responsive to software commands, such as from RDRT supervisor 610 or RDU driver 620, including the separate flow of RDU interrupt handler 628. Furthermore, RDRT supervisor 610 and RDU driver 620 may be configured to enable recovery of RDU 114 from a hung state (e.g., an inoperable state) that may be separate from operational states in RDU state buffer 1020 in the exemplary embodiments disclosed herein. In particular, the hung state may be associated with an RDU resource associated with RDU 114, selected from at least one of: RDU tile 802, RDU die 720, RDU 114, or RDU system 110. For example, recovery from the hung state may involve specific procedures or repeated attempts to recover when the actual operational condition associated with RDU 114 remains unknown or indeterminate, at least to a certain extent. Accordingly, the recovery actions for attaining a ready state from the hung state may include power down and power up restart sequences for at least one of the RDU resources.

FIG. 11 depicts RDRT supervisor operational states 1100 as a state machine diagram including activity associated with RDRT supervisor 610. Also shown in FIG. 11 is RDU state buffer 1020-1 showing certain defined RDU states, including some RDU states that are updated by RDRT supervisor 610, shown with a dashed line from a given RDU state, as will be explained below.

The RDU states included with RDU state buffer 1020-1 are as follows:
ABSENT 1110-1—is a placeholder state for an RDU slot in xRDU element 112 that is not populated with RDU 114, and so, indicates an instance of RDU 114 that is not physically present, ABSENT 1110-1 in RDU state buffer 1020-1 may be updated from ABSENT state 1110 by RDRT supervisor 610;
INIT 1112-1—is an initialization state for RDU 114 upon populating xRDU element 112 or recovering from FAULTED 1320 in certain instances, INIT 1112-1 in RDU state buffer 1020-1 may be updated from INIT state 1112 by RDRT supervisor 610;
READY 1114-1—is a ready and operating state indicating that RDU 114 is in nominal operating condition, whether prior to, during, or after execution of a workload, such that READY 1114 state indicates that no fault is detected in RDU 114, READY 1114-1 state in RDU state buffer 1020-1 is shown not being updated by RDRT supervisor 610 (see FIG. 12);
DEGRADED 1122—is a state of partial operation of RDU 114 indicating that at least one RDU resource in RDU 114 in in a fault condition or is not operating nominally, DEGRADED 1122 in RDU state buffer 1020-1 may be updated from READY state 1114 by RDRT supervisor 610;
QSC_PENDING 1116—is a quiescing pending state indicating that the at least one RDU resource found to be not operating normally or in a fault condition in DEGRADED state 1122 is being quiesced, such that other types of access to the corresponding RDU resource(s) may be illegal;
QSC_DONE 1124—is a quiescing done state indicating that the at least one RDU resource found to be not operating normally or in a fault condition in DEGRADED state 1122 has been quiesced, such that other types of access to the corresponding RDU resource(s) may be illegal, FAULTED 1126 in RDU state buffer 1020-1 may be updated from OP_PENDING state 1118 by RDRT supervisor 610;
FAULTED 1126—is a fault condition state for RDU 114, such as for at least one RDU resource; and
OP_PENDING 1118-1—indicates that a recovery operation or action to return the at least one RDU resource found to be not operating normally or in a fault condition in DEGRADED state 1122 is pending as indicated by OP_PENDING state 1118, OP_PENDING 1118-1 in RDU state buffer 1020-1 may be updated from OP_PENDING state 1118 by RDRT supervisor 610.

In operation, various transitions in RDRT supervisor operational states 1100 may occur. A transition 1130 between ABSENT 1110 and INIT 1112 may occur responsive to an RDU initialization event or a dynamic replacement for RDU 114. A transition 1132 between INIT 1112 and READY 1114 may occur responsive to successful initialization of RDU 114 and enumeration of RDU 114 in a device pool of available RDUs 114. A transition 1134 between READY 1114 and ABSENT 1110 may occur responsive to detection that RDU 114 no longer is physically present. A transition 1136 between READY 1114 and QSC_PENDING 1116 may occur responsive to detection that RDU 114 exhibited a fault and was indicated for quiescing to perform a corrective action that was diagnosed. A transition 1138 between QSC_PENDING 1116 and OP_PENDING 1118 may occur responsive to detection that in RDU 114 the corrective action that was diagnosed is pending completion. In particular embodiments, RDRT supervisor 610 may remain in OP_PENDING 1118 until faults are cleared on RDU 114. A transition 1140 between OP_PENDING 1118 and READY 1114 may occur responsive to detection that faults in RDU 114 have been cleared.

FIG. 12 depicts RDRT driver operational states 1200 as a state machine diagram including activity associated with RDRT driver 620. Also shown in FIG. 12 is RDU state buffer 1020-2 showing certain defined RDU states, including some RDU states that are updated by RDRT driver 620, shown with a dashed line from a given RDU state, as will be explained below.

The RDU states included with RDU state buffer 1020-2 are as follows:
ABSENT 1110-1—is shown not updated by RDRT driver 620;
INIT 1112-1—is shown not updated by RDRT driver 620;
READY 1114-2—is a ready and operating state indicating that RDU 114 is in nominal operating condition, whether prior to, during, or after execution of a workload, such that READY 1114 state indicates that no fault is detected in RDU 114, READY 1114-2 state in RDU state buffer 1020-1 is shown being updated by RDRT driver 620 from READY 1214 and QSC_DONE;
DEGRADED 1122—is shown not updated by RDRT driver 620;
QSC_PENDING 1216—is a quiescing pending state indicating that the at least one RDU resource found to be not operating normally or in a fault condition in DEGRADED state 1122 is being quiesced, such that other types of access to the corresponding RDU resource(s) may be illegal, QSC_PENDING 1116-2 state in RDU state buffer 1020-2 is shown being updated by RDRT driver 620 from QSC_PENDING 1216;
QSC_DONE 1218—is a quiescing done state indicating that the at least one RDU resource found to be not operating normally or in a fault condition in DEGRADED state 1122 has been quiesced, such that other types of access to the corresponding RDU resource(s) may be illegal, QSC_DONE 1218 in RDU state buffer 1020-2 may be updated from QSC_DONE 1218 by RDRT driver 620;
FAULTED 1126—is a fault condition state for RDU 114, such as for at least one RDU resource; and
OP_PENDING 1118-1—is shown not updated by RDRT driver 620.

In operation, various transitions in RDRT driver operational states 1200 may occur. A transition 1230 between between READY 1214 and QSC_PENDING 1216 may occur responsive to detection that RDU 114 exhibited a fault and was indicated for quiescing to perform a corrective action that was diagnosed. The quiescing can involve one or more RDU resources associated with RDU 114. A transition 1232 between QSC_PENDING 1216 and QSC_DONE 1218 may occur responsive to completing the quiescing. A transition 1234 between QSC_DONE 1218 and READY 1214 may occur responsive to detection that faults in RDU 114 have been cleared.

FIG. 13 depicts RDU states 1300 as a state machine diagram. RDU states correspond to RDU state buffer 1020 as described above.

In operation, various transitions in RDU states 1300 may occur. A transition 1330 between ABSENT 1310 and INIT 1312 may occur upon detecting a physical presence of RDU 114. A transition 1332 between INIT 1312 and READY 1314 may occur upon initialization of RDU 114. During normal operation, READY 1314 may remain the current state during or between processing of workloads by RDU 114 indicating a nominal operating condition. For example, workloads may be scheduled on RDU 114, executed on RDU 114, and successfully completed on RDU 114 while in state READY 1314 (also 1114, 1214). A transition 1332 between READY 1314 and DEGRADED 1315 may occur when INIT 1312 or DIAG 1313 generated an error, such as indicating an RDU resource in RDU 114 that did not initialize without some error and that RDU 114 is degraded. A transition 1334 between DEGRADED 1315 and QSC_PENDING 1316 may occur when quiescing of the RDU resource was indicated and is in progress. A transition 1336 between QSC_PENDING 1316 and QSC_DONE 1318 may occur when quiescing the RDU resource is complete. Transitions 1334 and 1336 may involve draining RDU 114 of data and configuration information associated with a workload in progress. A transition 1338 between QSC_DONE 1318 and OP_PENDING 1319 may occur when a recovery action with respect to the RDU resource is in progress. A transition 1340 between OP_PENDING 1319 and READY 1314 may occur when the recovery action with respect to the RDU resource succeeds. A transition 1342 between OP_PENDING 1319 and FAULTED 1320 may occur when the recovery action with respect to the RDU resource does not succeed and generates an error. In particular embodiments, when the RDU state is OP_PENDING 1319, a second error may be received that the workload was not successfully completed. The second error may be associated with a second portion of the RDU or with a timeout of the recovery action. After the second error, the RDU state may transition to FAULTED 1320.

A transition 1344 between FAULTED 1320 and INIT 1312 may occur to reset RDU 114. A transition 1346 between INIT 1312 and DIAG 1313 may occur to perform a diagnostic on RDU 114, such as after transition 1344. A transition 1348 between DIAG 1313 and READY 1314 may occur after diagnostics are complete. A transition 1350 between READY 1314 and ABSENT 1310 may occur when a physical absence of RDU 114 is detected.

As noted, FIGS. 11, 12 and 13 depict hardware monitoring and management in cases where recoverable faults occur and can be handled using hardware elements and RDU resources that remain responsive. In other embodiments, as noted, certain RDU resources may go into the hung state, as explained previously. For this purpose, methods and operations for hardware fault detection and recovery may be performed by RDU subsystem 1000.

The hung state of an RDU resource RDU can be detected by RDU subsysten, such as for RDU resources selected from at least one of: an RDU tile, an RDU die, or the RDU. Then, a a recovery mechanism associated with the RDU resource can be initiated, such that the RDU resource is returned to an operational state, such as given by RDU states 1300, from the hung state. The hung state of the RDU resource can be associated with a bitfile associated with executable file 530 that comprises compiled instructions executable by RDU 114 for configuring RDU 114 to execute the workload. Prior to initiating the recovery mechanism, such as from RDU state FAULTED 1320, at least a portion of the workload may be retried on RDU 114 and the recovery mechanism may be initiated after multiple retry attempts have also failed.

In particular embodiments of hardware fault detection and recovery, the RDU may be one of multiple RDUs 114 being used to execute the workload. In some embodiments, executable file 530 may be compiled to include checkpoints that enable rolling back of execution of the workload to a defined state, such as in order to successfully complete a portion of the workload prior to a given checkpoint. Each checkpoint upon completion may be marked as successful and the results of the workload up to the checkpoint may be similarly indicated. When the workload fails due to the hung state, a rollback to a last successful checkpoint may enable the workload to be restarted without losing previous results up to a previous successful checkpoint, such as a last successful checkpoint. In this manner, repetitive execution of portions of the workload that were successfully executed can be avoided, which is desirable.

In particular embodiments of hardware fault detection and recovery, detecting the hung state of RDU 114 may include detecting a timeout associated with a control-status register (CSR) on RDU 114. The CSR may be associated with a particular RDU resource. When the hung state is detected, additional portions of the workload that might be pending may be prevented from being processed by RDU 114. When the hung state is detected and confirmed, such as after multiple retry attempts for example, the workload can be designated as failing to execute on RDU 114. In this case, the RDU state FAULTED 1320 can be designated in some embodiments. After attempting to reinitialize fails, quiescing of RDU 114 or an RDU resource may be performed, as described above.

In order to recover from the hung state and to reinstate RDU 114 in the resource pool (READY 1314) RDU subsystem 1000 may be configured to use certain reset mechanisms provided in hardware in RDU 114 for this purpose. The reset mechanisms may be different from diagnostic errors discovered in DIAG 1313 when RDU 114 or an RDU resource is still operating and responding and is not in the hung state. The reset mechanism may involve a sequence of hardware accesses, such as CSR monitoring and programming, along with certain proscribed responses or timeouts, which can define control mechanisms associated with particular RDU resources. Such reset or control mechanisms can be defined by hardware documentation of software routines for a given implementation of RDU 114, for example. Sometimes, certain reset or control mechanisms may fail on a first attempt but be successful on a subsequent attempt, and therefore, can be retried a number of times in various embodiments.

In order to implement the reset mechanism, the RDU resources may be reset in a hierarchical order, such as starting with RDU tile 802, then RDU die 720, then RDU 114, then xRDU 112, and finally a global reset of RDU system 110. As soon as a reset in this cycling order succeeds in bringing RDU 114 into RDU state READY 1314, the cycling through the reset hierarchy can be stopped and nominal operation of RDU 114 can commence. As a final resort, when all reset mechanisms have failed to bring RDU 114 into RDU state READY 1314, a power reset (power down followed by power up) can be performed to restart RDU system 110, for example. In this manner, RDRT architecture 600 can be configured to handle various types of faults and faulted conditions that RDU system 110 may experience, and to recover in a defined and predictable manner, in various embodiments.

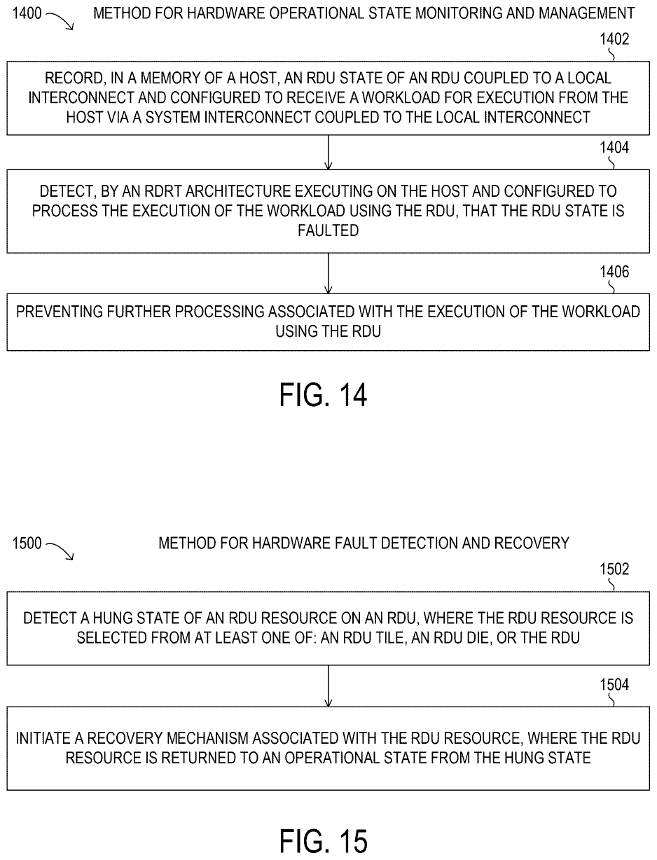

Referring now to FIG. 14, a flowchart of selected elements of an embodiment of a method 1400 for hardware operational state monitoring and management in reconfigurable dataflow architecture 100, as described herein, is depicted. Method 1400 may be performed using various hardware and software elements in reconfigurable dataflow architecture 100, as described above. In particular embodiments, at least certain portions of method 1400 may be performed using RDU subsystem 1000, as described with respect to FIG. 10, for example. It is noted that certain operations described in method 1400 may be optional or may be rearranged in different embodiments.

Method 1400 may begin at step 1402 by recording, in a memory of a host, an RDU state of an RDU coupled to a local interconnect and configured to receive a workload for execution from the host via a system interconnect coupled to the local interconnect. At step 1404, the RDU state of FAULTED is detected by an RDRT architecture executing on the host and configured to process the execution of the workload using the RDU. At step 1406, further processing associated with the execution of the workload using the RDU is prevented.

Referring now to FIG. 15, a flowchart of selected elements of an embodiment of a method 1500 for hardware fault detection and recovery in reconfigurable dataflow architecture 100, as described herein, is depicted. Method 1500 may be performed using various hardware and software elements in reconfigurable dataflow architecture 100, as described above. In particular embodiments, at least certain portions of method 1500 may be performed using RDU subsystem 1000, as described with respect to FIG. 10, for example. It is noted that certain operations described in method 1500 may be optional or may be rearranged in different embodiments.

Method 1500 may begin at step 1502 detect a hung state of an RDU resource on an RDU, where the RDU resource is selected from at least one of: an RDU tile, an RDU die, or the RDU. At step 1504, a recovery mechanism associated with the RDU resource is initiated, where the RDU resource is returned to an operational state from the hung state.

As disclosed herein, a system includes an RDU coupled to a local interconnect and configured to receive a workload for execution from a host via a system interconnect coupled to the local interconnect, and an RDRT architecture executing on the host and configured to record, in a memory of the host, an RDU state of the RDU, and, when the RDU state is FAULTED, prevent further processing associated with the execution of the workload using the RDU

As disclosed herein, a system includes an RDU coupled to a local interconnect and configured to receive a workload for execution from a host via a system interconnect coupled to the local interconnect, and an RDRT architecture executing on the host and configured to detect a hung state of an RDU resource on the RDU and initiate a recovery mechanism associated with the RDU resource. The RDU resource is selected from at least one of an RDU tile, an RDU die, or the RDU. From the recovery mechanism, the RDU resource is returned to an operational state from the hung state.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A system comprising:
a reconfigurable dataflow unit (RDU) coupled to a local interconnect and configured to receive a workload for execution from a host via a system interconnect coupled to the local interconnect; and
a reconfigurable dataflow runtime (RDRT) architecture executing on the host and configured to process the execution of the workload using the RDU, the RDRT architecture configured to:
record, in a memory of the host, an RDU state of the RDU; and
when the RDU state is FAULTED, prevent further processing associated with the execution of the workload using the RDU.

2. The system of claim 1, wherein the RDRT architecture is further configured to:
determine that the RDU state OP_PENDING for a recovery action generated a fault;
transition the RDU state to FAULTED;
transition the RDU state to INIT for an initialization;
when the initialization fails, transition the state to DIAG for a diagnostic; and
after the diagnostic or when the initialization succeeds, transition the state to READY.

3. The system of claim 2, wherein the RDRT architecture is further configured to:
detect presence of the RDU when the RDU state is ABSENT;
responsive to detecting presence of the RDU, transition the RDU state to INIT;
responsive to detecting the RDU state is INIT, trigger an initialization of at least a portion of the RDU;
transition the RDU state to READY when the initialization succeeds; and
responsive to detecting absence of the RDU, transition the RDU state to ABSENT.

4. The system of claim 2, wherein the RDRT architecture configured to transition the RDU state to READY is further configured to:
responsive to receiving a first error generated in INIT or DIAG, transition the RDU state to DEGRADED, wherein the first error indicates constrained operation of the RDU;
begin quiescing a first portion of the RDU associated with the first error and transition the RDU state to QSC_PENDING;
confirm the quiescing of the first portion and transition the RDU state to QSC_DONE;
transition the RDU state to OP_PENDING while the recovery action is performed; and
transition the RDU state to READY when the recovery action is successfully completed.

5. The system of claim 1, wherein the RDRT architecture is further configured to:
responsive to detecting that the RDU state is READY, receive a first workload for execution the RDU; and
process the workload for execution on the RDU.

6. The system of claim 5, wherein the RDRT architecture is further configured to:
when the RDU state is READY, receive an indication that the workload was successfully completed.

7. The system of claim 5, wherein the RDRT architecture is further configured to:
when the RDU state is OP_PENDING, receive a second error that the workload was not successfully completed, wherein the second error is associated with a second portion of the RDU or is associated with a timeout; and
responsive to the second error, transition the RDU state to FAULTED.

8. A method comprising:
recording, in a memory of a host, an RDU state of a reconfigurable dataflow unit (RDU) coupled to a local interconnect and configured to receive a workload for execution from the host via a system interconnect coupled to the local interconnect;
detecting, by a reconfigurable dataflow runtime (RDRT) architecture executing on the host and configured to process the execution of the workload using the RDU, that the RDU state is FAULTED; and
preventing further processing associated with the execution of the workload using the RDU.

9. The method of claim 8, further comprising:
determining that the RDU state OP_PENDING for a recovery action generated a fault;
transitioning the RDU state to FAULTED;
transition the RDU state to INIT for an initialization;
when the initialization fails, transitioning the state to DIAG for a diagnostic; and
after the diagnostic or when the initialization succeeds, transitioning the state to READY.

10. The method of claim 9, further comprising:
detecting presence of the RDU when the RDU state is ABSENT;
responsive to detecting presence of the RDU, transitioning the RDU state to INIT;
responsive to detecting the RDU state is INIT, triggering an initialization of at least a portion of the RDU;
transitioning the RDU state to READY when the initialization succeeds; and
responsive to detecting absence of the RDU, transitioning the RDU state to ABSENT.

11. The method of claim 10, wherein transitioning the RDU state to READY further comprises:
responsive to receiving a first error generated during the initialization of the RDU, transitioning the RDU state to DEGRADED, wherein the first error indicates constrained operation of the RDU;
beginning quiescing a first portion of the RDU associated with the first error and transition the RDU state to QSC_PENDING;
confirming the quiescing of the first portion and transition the RDU state to QSC_DONE;
transitioning the RDU state to OP_PENDING while the recovery action is performed; and
transitioning the RDU state to READY when the recovery action is successfully completed.

12. The method of claim 8, further comprising:
responsive to detecting that the RDU state is READY, receiving a first workload for execution the RDU;
processing the workload for execution on the RDU; and
when the RDU state is READY, receiving an indication that the workload was successfully completed.

13. The method of claim 12, further comprising:
when the RDU state is OP_PENDING, receiving a second error that the workload was not successfully completed, wherein the second error is associated with a second portion of the RDU or is associated with a timeout; and
responsive to the second error, transitioning the RDU state to FAULTED.

14. Tangible computer-readable media comprising instructions executable by a computer system to:
record, in a memory of a host, an RDU state of a reconfigurable dataflow unit (RDU) coupled to a local interconnect and configured to receive a workload for execution from the host via a system interconnect coupled to the local interconnect;
detect, by a reconfigurable dataflow runtime (RDRT) architecture executing on the host and configured to process the execution of the workload using the RDU, that the RDU state is FAULTED; and
prevent further processing associated with the execution of the workload using the RDU.

15. The computer-readable media of claim 14, further comprising instructions to:
determine that the RDU state OP_PENDING for a recovery action generated a fault;
transition the RDU state to FAULTED;
transition the RDU state to INIT for an initialization;
when the initialization fails, transition the state to DIAG for a diagnostic; and
after the diagnostic or when the initialization succeeds, transition the state to READY.

16. The computer-readable media of claim 15, further comprising instructions to:
detect presence of the RDU when the RDU state is ABSENT;
responsive to detecting presence of the RDU, transition the RDU state to INIT;
responsive to detecting the RDU state is INIT, trigger an initialization of at least a portion of the RDU;
transition the RDU state to READY when the initialization succeeds; and
responsive to detecting absence of the RDU, transition the RDU state to ABSENT.

17. The computer-readable media of claim 16, wherein the instructions to transition the RDU state to READY further comprise instructions to:
responsive to receiving a first error generated during the initialization of the RDU, transition the RDU state to DEGRADED, wherein the first error indicates constrained operation of the RDU;
begin quiescing a first portion of the RDU associated with the first error and transition the RDU state to QSC_PENDING;
confirm the quiescing of the first portion and transition the RDU state to QSC_DONE;
transition the RDU state to OP_PENDING while the recovery action is performed; and
transition the RDU state to READY when the recovery action is successfully completed.

18. The computer-readable media of claim 14, further comprising instructions to:
responsive to detecting that the RDU state is READY, receive a first workload for execution the RDU; and
process the workload for execution on the RDU.

19. The computer-readable media of claim 18, further comprising instructions to:
when the RDU state is READY, receive an indication that the workload was successfully completed.

20. The computer-readable media of claim 18, further comprising instructions to:
when the RDU state is OP_PENDING, receive a second error that the workload was not successfully completed, wherein the second error is associated with a second portion of the RDU or is associated with a timeout; and
responsive to the second error, transition the RDU state to FAULTED.
